(19) United States
(12) Patent Application Publication
(10) Pub. No.: US 2024/0015741 A1
(43) Pub. Date: Jan. 11, 2024

(54) BEAM MANAGEMENT AND MULTI-BEAM OPERATION FOR NR FROM 52.6 GHZ AND ABOVE

(71) Applicant: IPLA Holdings Inc., New York, NY (US)

(72) Inventors: Allan TSAI, Wilmington, DE (US); Patrick SVEDMAN, Wilmington, DE (US); Kyle PAN, Wilmington, DE (US); Pascal ADJAKPLE, Wilmington, DE (US); Mohamed AWADIN, Wilmington, DE (US); Yifan LI, Wilmington, DE (US); Guodong ZHANG, Wilmington, DE (US)

(73) Assignee: IPLA Holdings Inc., New York, NY (US)

(21) Appl. No.: 18/271,044

(22) PCT Filed: Jan. 13, 2022
(86) PCT No.: PCT/US2022/012305

§ 371 Date: Jul. 6, 2023

Related U.S. Application Data
(60) Provisional application No. 63/136,846, filed on Jan. 13, 2021.

(51) Int. Cl. H04W 72/1273; H04W 72/232; H04L 25/02

(52) U.S. Cl. CPC H04W 72/1273; H04W 72/232; H04L 25/0204

(57) ABSTRACT

In Methods, apparatus, and systems are described for improved beam management and multi-beam operation for 5G New Radio (NR). According to some aspects, spatial coverage may be enhanced for user equipment (UE) for NR from 52.6 GHz and above. A UE may receive a plurality of Transmission Configuration Indication (TCI) states, wherein each of the TCI states corresponds to a Physical Downlink Control Channel (PDCCH) or a plurality of scheduled Physical Downlink Shared Data Channel (PDSCH). The UE may determine a channel estimator for channel estimation by combining each of the TCI states.

### CROSS-REFERENCE TO RELATED APPLICATIONS

This application claims the benefit of U.S. Provisional Application No. 63/136,846, filed Jan. 13, 2021, entitled “Beam Management and Multi-Beam Operation for NR from 52.6 GHZ and Above,” the contents of which are hereby incorporated by reference in their entirety.

### BACKGROUND

For NR from 52.6 GHz and above, beam management needs to consider the impact of narrower beamwidths on UE in idle/inactive state for the impaction of idle/inactive state, e.g., shorter cyclic prefix (CP) duration due to larger sub-carrier spacing (SCS) being introduced, multiple beam indications for multi-PUSCH/PDSCH scheduling, enhancements to beam management for random access procedure, small data transmission in RRC idle/inactive state, intra- and/or inter-cell mobility, and adaptation to LBT failures, etc.

In Rel-16, PDSCH reliability enhancements (e.g., PDSCH repetition and transmission from multiple TRPs) have been specified. PDSCH reliability enhancement can support different multiplexing schemes such as spatial division multiplexing (SDM), frequency domain multiplexing (FDM) and time domain multiplexing (TDM). In addition, In Rel-17, PDCCH reliability enhancements (e.g., PDCCH repetition and transmission from multiple TRPs) may be discussed. In Rel-17, PDCCH reliability enhancement can support PDCCH FDM, TDM and SFN scheme in which a single DMRS port is associated with two TCIs scheme. However, due to PDCCH processing limitation as a result of a shorter slot duration assuming the same UE processing capability per a given time unit, and narrower beams transmission and reception for NR from 52.6 GHz and above, the support of multiplexing schemes and TCI indications for PDSCH in Rel-16 and PDCCH reliability enhancement in Rel-17 may not directly apply to the single DCI scheduling of multiple PDSCHs for NR from 52.6 GHz above. For example, FDM requires processing two PDCCH candidates which may increase the PDCCH processing complexity per slot or TDM per span. SDM scheme for PDCCH needs to be introduced either based on single or two DMRS ports.

Rel-15/16 beam reporting framework has a limited capability to efficiently enable multi-beam high rank transmission in single/multi-TRP (M-TRP) or multiple panels (MP) environment. Achieving high rank transmission via either for M-TRP or MP transmission requires lower spatial correction among different beams or spatial information. UE may report the neighbor SSB ID since those neighbor SSB also given better L1-RSRP. Therefore, UE may report higher spatial correlation.

Beam management and multi-beam operation for NR from 52.6 GHz and above deployments may encompass a wide variety of scenarios, servers, gateways, and devices, such as those described in, for example: 3GPP TS 38.213 NR, Physical layer procedures for control, (Release 16), V16.2.0; and 3GPP TS 38.214 NR, Physical layer procedures for data (Release 16), V16.2.0.

### SUMMARY

Described herein are methods, apparatus, and systems for improved beam management and multi-beam operation for NR from 52.6 GHZ and above, which address the shortcomings discussed above.

According to some aspects, spatial coverage enhancement methods are provided for idle/inactive mode User Equipment (UE). For example, spatial coverage enhancement methods for idle/inactive mode UE may include increasing a number of SSB. As another example, spatial coverage enhancement methods for idle/inactive mode UE may include CSI-RS/TRS for idle/inactive state UE, e.g., the configuration and availability of CSI-RS/TRS for idle/inactive state UE or a beam reporting method when CSI-RS/TRS is available for idle/inactive state UE.

According to some aspects, multi-beam transmission and indication for single DCI schedule multi PDSCH are provided. For example, TCI state indication methods for single DCI schedule multi PDSCH may use an SFN scheme for single DCI schedule multi PDSCH to save DCI overhead or a common beam may be applied for single DCI schedule multi PDSCH. As another example, TCI states indication methods for NR-U may include an aperiodic CSI-RS report method with and without LBT constraint.

According to some aspects, enhanced CSI report quantity for multi-beams is provided.

According to some aspects, a User Equipment (UE) may comprise a processor, communications circuitry, and a memory comprising instructions which, when executed by the processor cause the apparatus to perform one or more operations.

According to some aspects, spatial coverage may be enhanced for UE for 5G New Radio (NR) from 52.6 GHz and above. The UE may receive a plurality of Transmission Configuration Indication (TCI) states, wherein each of the TCI states corresponds to a Physical Downlink Control Channel (PDCCH) or a plurality of scheduled Physical Downlink Shared Data Channel (PDSCH). The UE may determine a channel estimator for channel estimation by combining each of the TCI states.

According to some aspects, a plurality of TCI states may be received for a multi-Transmission and Reception Point (TRP) environment. In some aspects, both the PDCCH and the plurality of scheduled PDSCH may be indicated using the same Quasi-CoLocation (QCL) information. The TCI states may be indicated in a Downlink Control Information (DCI) format. According to some aspects, the UE may determine, based on a time offset between a reception of a downlink (DL) Downlink Control Information (DCI) and a corresponding PDSCH being equal to or greater than a threshold, a first Division Multiplexing Reference Signal (DM-RS) port of the PDSCH and a second Division Multiplexing Reference Signal (DM-RS) port of the PDCCH of a serving cell are Quasi-CoLocationed with one or more reference signals (RSs) in the plurality of TCI states.

According to some aspects, the UE may determine, based on a time offset between a reception of a downlink (DL) Downlink Control Information (DCI) and a corresponding PDSCH being less than a threshold, DM-RS ports of PDSCH are QCLed type A or D with the DM-RS of the current received DCI or a current Transmission Configuration Indication (TCI) state.

According to some aspects, beam refinement or multi-beam reception may be enabled based on one or more Channel State Information (CSI)—Reference Signal (RS) reports.

According to some aspects, a synchronization signal/physical broadcast channel block (SSB), a common control resource set (CORESET), and a channel state information—reference signal/tracking reference signal (CSI-RS/TRS) may have a matching sub-carrier spacing (SCS).

According to some aspects, a non-zero-power channel state information—reference signal/tracking reference signal (CSI-RS/TRS) may be transmitted with a paging channel in a paging monitoring occasion and the CSI-RS/TRS may be quasi co-located (QCLed) with a synchronization signal/physical broadcast channel block (SSB) and a Division Multiplexing Reference Signal (DM-RS) port of the PDCCH and the plurality of scheduled PDSCH.

According to some aspects, the UE may monitor a group common Physical Downlink Control Channel (PDCCH) before receiving a paging Physical Downlink Control Channel (PDCCH). Moreover, the UE may determine a listen before talk failure if the group common PDCCH is not received for a plurality of channel state information—reference signal/tracking reference signal (CSI-RS/TRS) identifiers.

According to some aspects, a beam failure may be determined based on an aperiodic channel state information—reference signal (CSI-RS).

According to some aspects, an apparatus such as a next generation Node B (gNB) may comprise a processor, communications circuitry, and a memory comprising instructions which, when executed by the processor cause the apparatus to perform on or more operations. According to some aspects, the gNB may transmit a paging message. For example, a scheduling request (SR) procedure may be initiated based on the paging message. Moreover, a plurality of Transmission Configuration Indication (TCI) states may be transmitted. For example, each of the TCI states may correspond to a Physical Downlink Control Channel (PDCCH) or a Physical Downlink Shared Data Channel (PDSCH).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example of an SSB design for SCS=960 KHz with 128 SSB blocks in a synchronization burst;

FIG. 2 shows an example of an SSB design for SCS=960 KHz with 64 SSB blocks in a synchronization;

FIG. 3A shows an example of CSI-RS/TRS transmission occasion for idle/inactive mode UE, e.g., a single CSI-RS/TRS associated with a MO in a PO;

FIG. 3B shows an example of CSI-RS/TRS transmission occasion for idle/inactive mode UE, e.g., multiple CSI-RS/TRS associated with a MO in a PO (c) multiple CSI-RS/TRS associated with multiple MOs in a PO.;

FIG. 3C shows an example of CSI-RS/TRS transmission occasion for idle/inactive mode UE, e.g., multiple CSI-RS/TRS associated with multiple MOs in a PO.;

FIG. 4 shows an example of CSI-RS/TRS transmission occasion for idle/inactive mode UE;

FIG. 5 shows an example of TRS and CSI-RS transmission occasion for idle/inactive mode UE;

FIG. 6 shows an example of a design of implicit CSI-RS/TRS report use a group of PRACH preambles for idle/inactive mode UE;

FIG. 7A shows an example of a single DCI schedule multiple (e.g., two) PDSCHs from M-TRP for NR from 52.6 GHz and above;

FIG. 7B shows an example of a single DCI schedule multiple (e.g., two) PDSCHs from M-TRP with repetition of multiple PDSCHs for NR from 52.6 GHz and above;

FIG. 8 shows an example of a DCI update TCI states and the effective time for beam switching;

FIG. 9 shows an example of a procedure of updating TCI states for NR-U from 52.6 GHz and above;

FIG. 10A illustrates an example communications system.

FIGS. 10B, 10C, and 10D are system diagrams of example RANs and core networks.

FIG. 10E illustrates another example communications system.

FIG. 10F is a block diagram of an example apparatus or device, such as a WTRU.

FIG. 10G is a block diagram of an exemplary computing system.

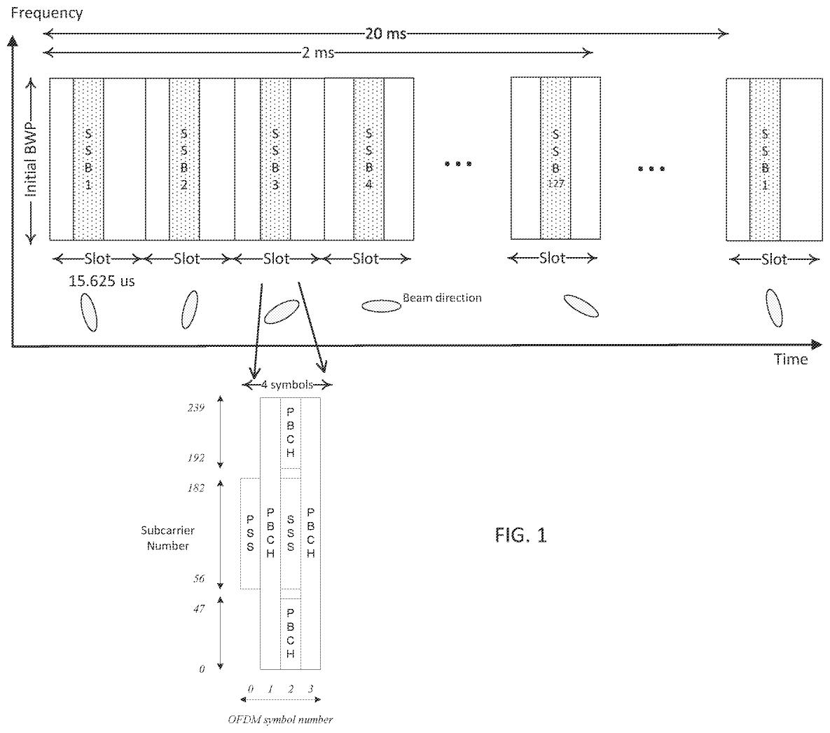

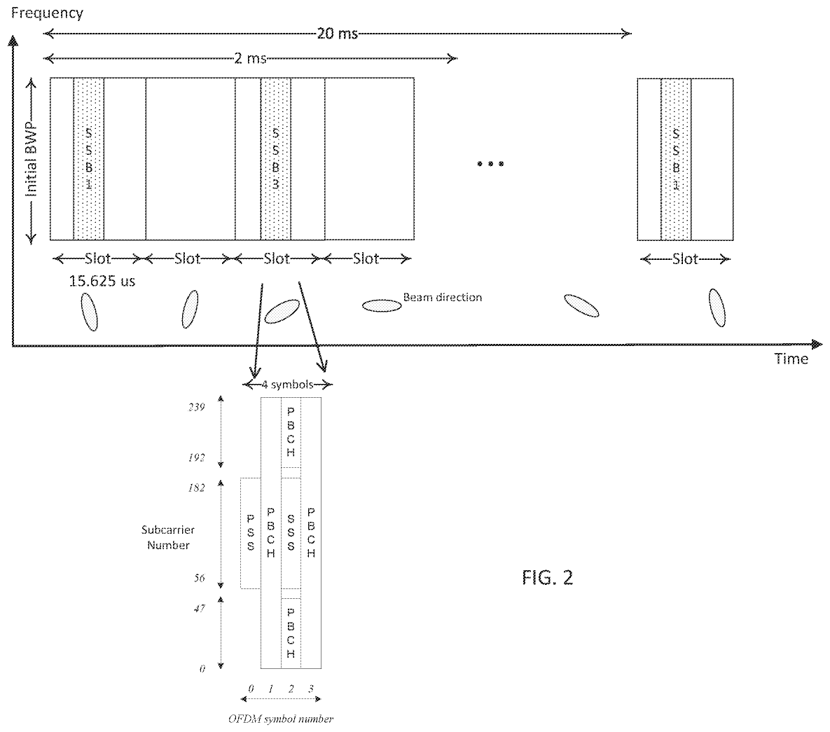

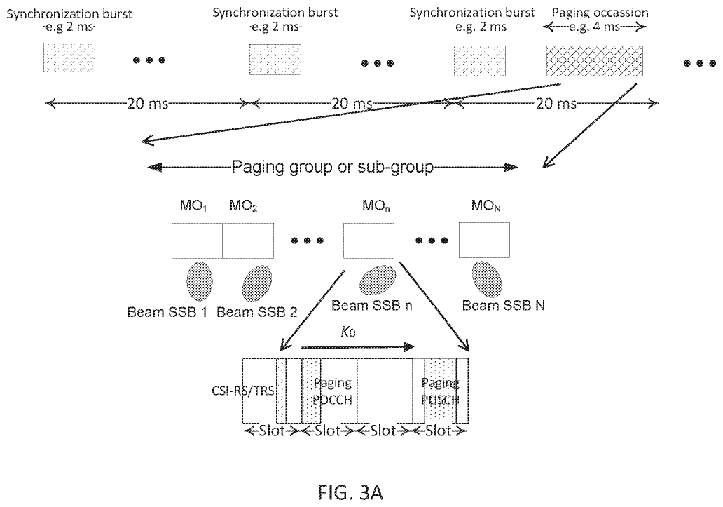

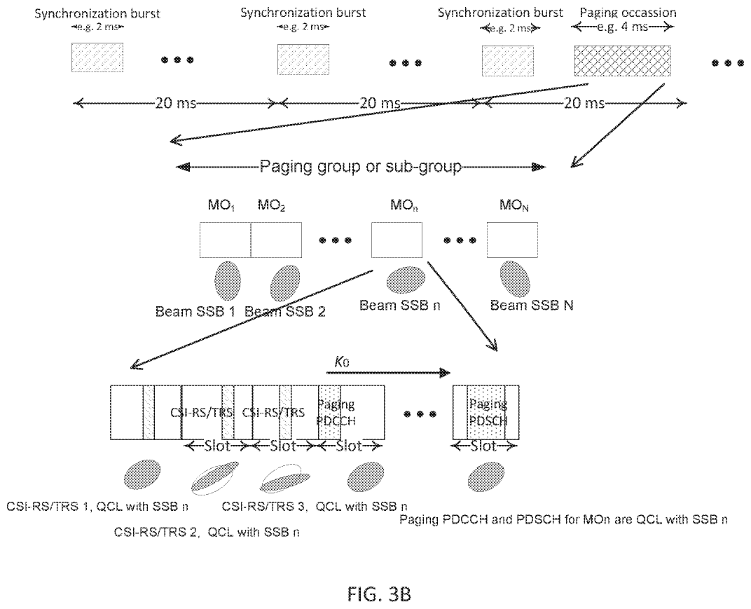

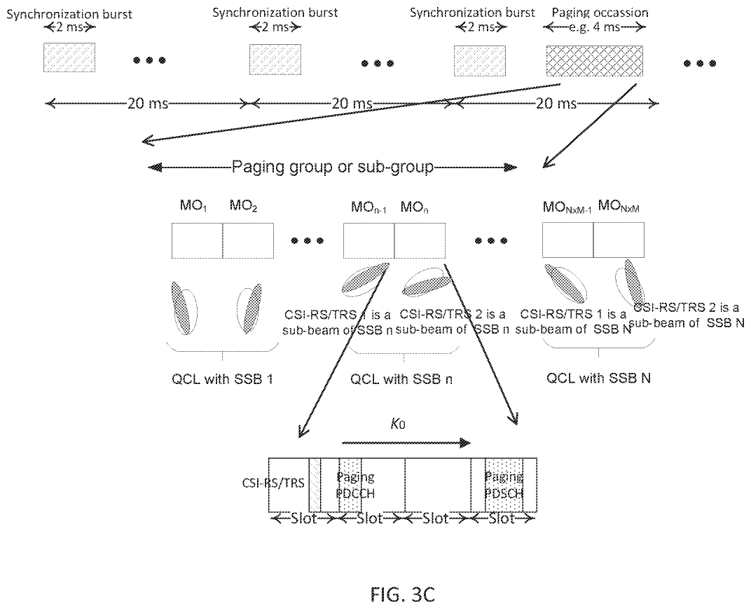

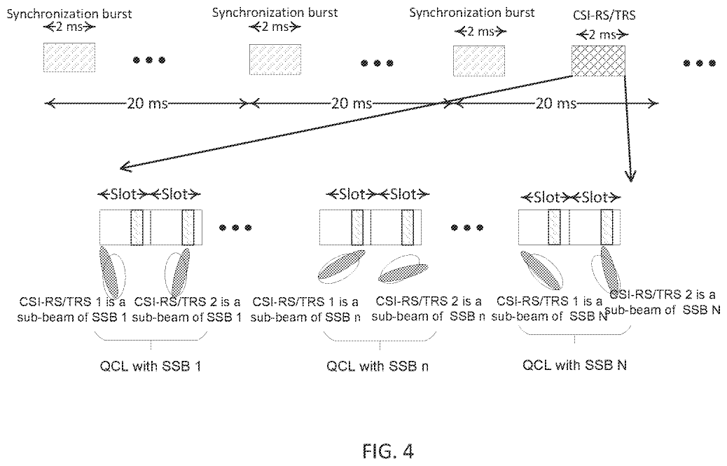

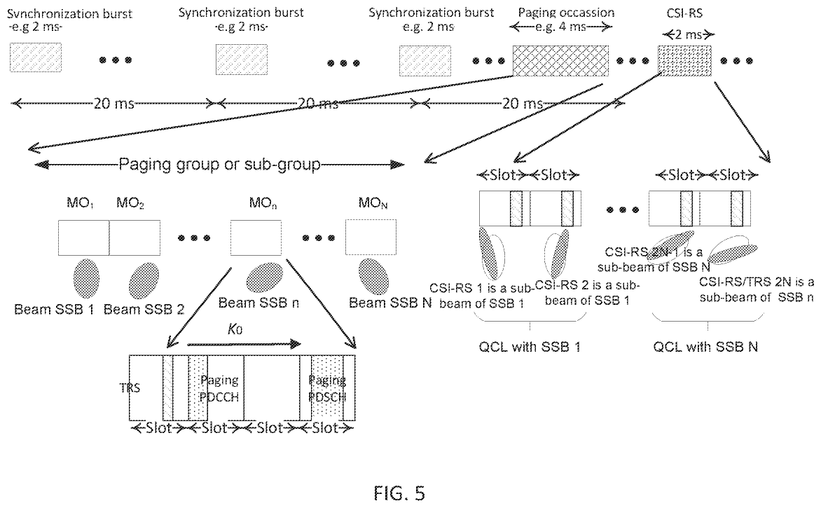

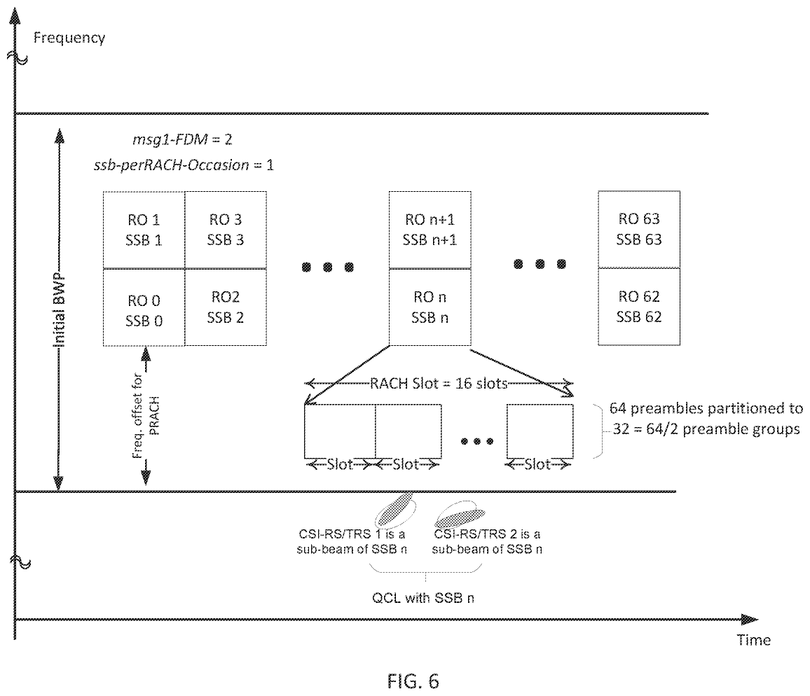

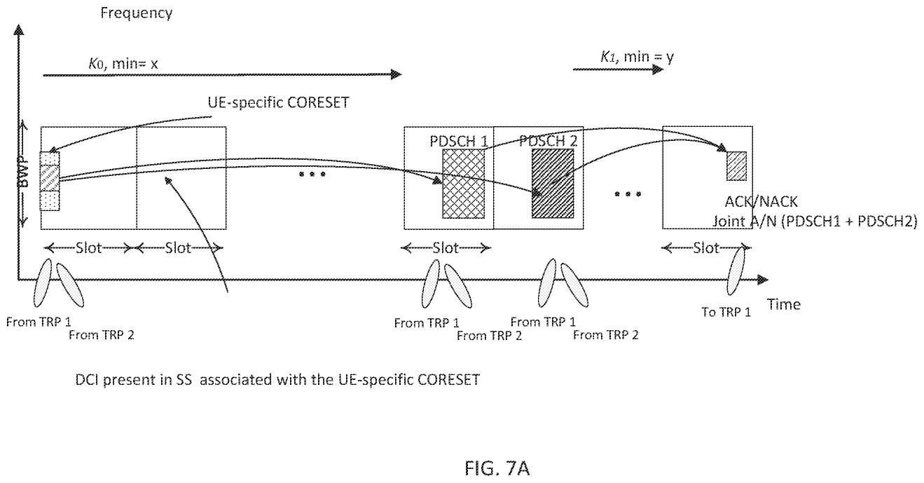

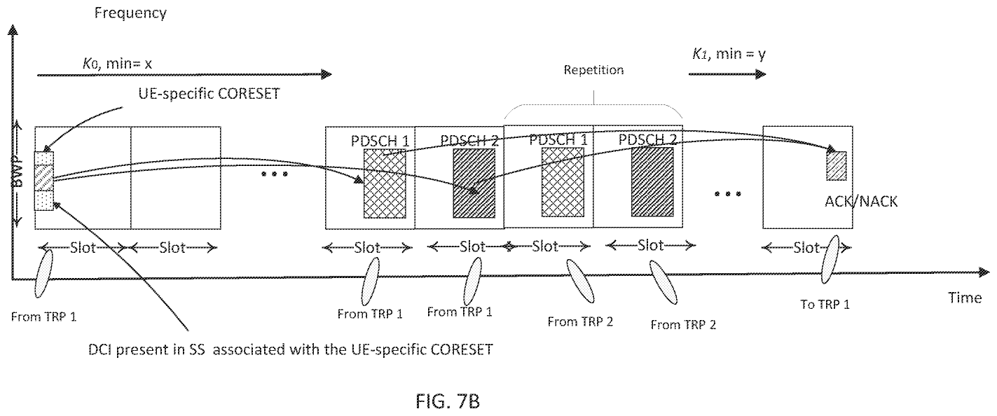

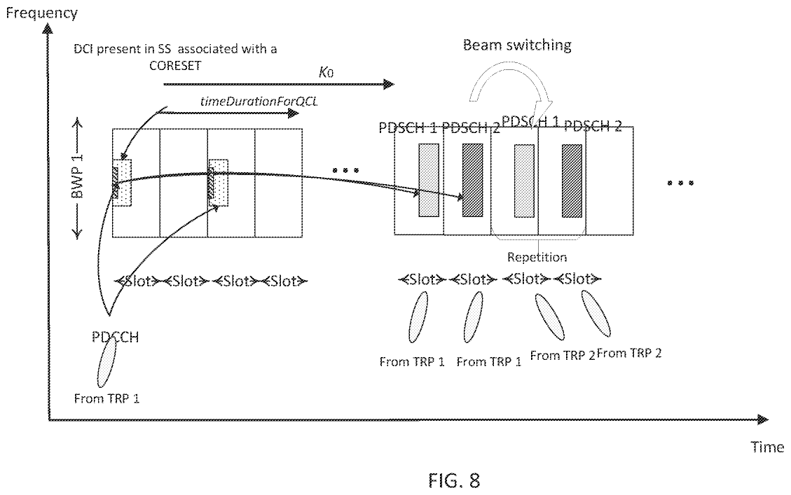

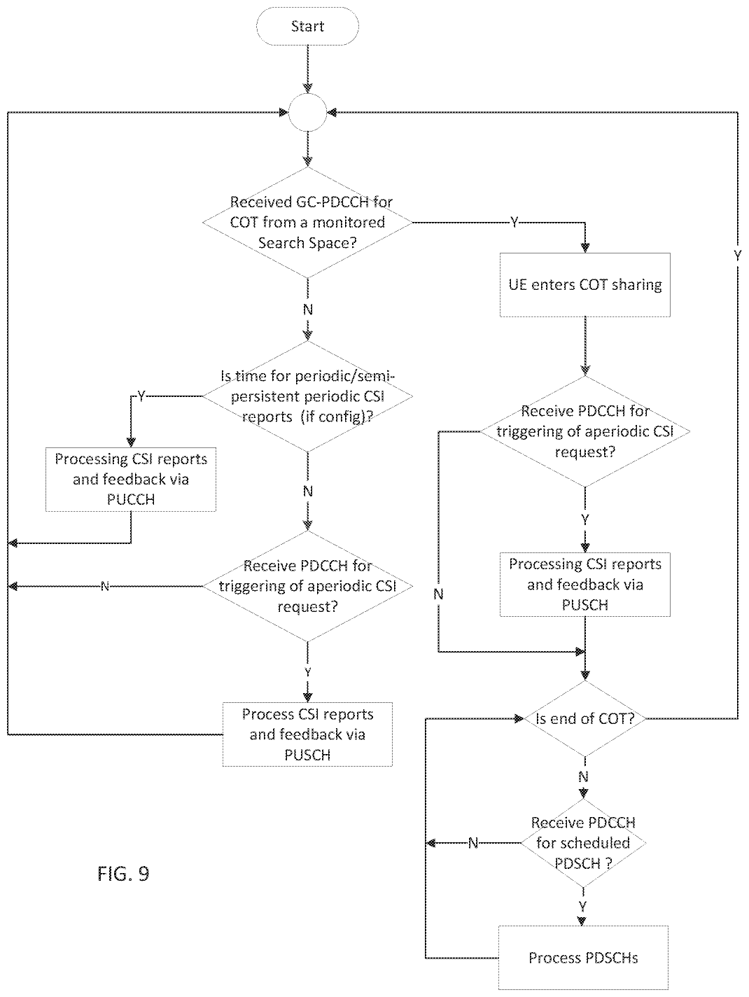

### DETAILED DESCRIPTION

Table 0.1 describes some of the abbreviations used herein.

TABLE 0.1
Abbreviations

| | |
|---|---|
| A/N | Ack/Nack |
| AL | Aggregation Level |
| API | Application Program Interface |
| AS | Access Stratum |
| BCCH | Broadcast Control Channel |
| BCH | Broadcast Channel |
| BD | Blind Decoding |
| CC | Component Carrier |
| CE | Control Element |
| CN | Core Network |
| CB | Code Block |
| CBG | Code Block Group |
| CCE | Control Channel Elements |
| CORESET | Control Resource Set |
| CP | Cyclic Prefix |
| CRI | CSI-RS Resource Indicator |
| CRC | Cyclic Redundancy Check |
| C-RNTI | Cell Radio-Network Temporary Identifier |
| CSI | Channel State Information |
| DCI | Downlink Control Information |
| DL | Downlink |
| DL-SCH | Downlink Shared Channel |
| DRX | Discontinuous Reception |
| DTX | Discontinuous Transmission |
| EMBB | Enhanced Mobile Broadband |
| FDRA | Frequency Domain Resource Assignment |
| FFS | For Further Study |
| FR1 | Frequency Range 1 |
| FR2 | Frequency Range 2 |
| GP | Guard Period |
| HARQ | Hybrid Automatic Repeat Request |
| HD | High Definition |
| IE | Information element |
| LBT | Listen Before Talk |
| LoS | Line of Sight |
| LTE | Long term Evolution |
| MAC | Medium Access Control |
| MCL | Maximum Coupling Loss |
| MIMO | Multiple-Input Multiple-Output |
| MPL | Maximum Path Loss |
| M-TRP | Multiple Transmit Receive Point |
| NAS | Non-access Stratum |
| NACK | Non-ACKnowledgement |
| NR | New Radio |
| NR-DRS | NR Reference signal in Downlink |
| | (typically used for channel estimation) |
| RS | Reference signal |
| OFDM | Orthogonal frequency division |
| | multiplexing |
| PDCCH | Physical Downlink Control Channel |
| PDSCH | Physical Downlink Shared Data Channel |
| PDU | Protocol Data Unit |
| PUSCH | Physical Uplink Shared Channel |
| PRACH | Physical Random Access Channel |
| PRB | Physical Resource Block |
| QCL | Quasi-CoLocation |
| RAN | Radio Access Network |
| RAT | Radio Access Technology |
| RB | Resource block |
| RE | Resource Element |
| RI | Rank Indicator |
| RIV | Resource Indication Value |
| RNTI | Radio Network Temporary Identifier |
| RRC | Radio Resource Control |
| SFN | Single Frequency Network |
| SI | System Information |
| SIB | System Information Block |
| SI-RNTI | System Information RNTI |
| SLIV | Start and Length Indicator Value |
| SPS-RNTI | Semi persistent scheduling RNTI |
| SR | Scheduling Request |
| SRI | SRS Resource Indicator |
| SRS | Sounding Reference Signal |
| SS | Search Space |
| TBS | Transport Block Size |
| TB | Transport Block |
| TCI | Transmission configuration indication |
| TDD | Time Division Duplex |
| TDRA | Time Domain Resource Assignment |
| TRP | Transmission and Reception Point |
| TRS | Tracking Reference Signal |
| UE | User Equipment |
| UCI | Uplink Control Information |
| UL | Uplink |
| UR/LL | Ultra Reliable - Low Latency |
| URLLC | Ultra-Reliable and Low Latency |
| | Communications |
| WLAN | Wireless Local Area Network |

### Beam Management in NR Rel-15 and -16

Beam management can be categorized as three parts in NR: (1) Initial beam establishment; (2) beam adjustment, primarily to compensate for movements and rotations of the mobile device, but also for gradual changes in the environment; and (3) beam recovery to handle the situation when rapid changes in the environment occur.

Three phases of DL beam management can be used with beam sweeping on TRP and/or UE side as described below:

Phase 1—Beam selection: the gNB or TRP sweeps beams and UE selects one or more best beams and report its selection to gNB. The UE selects a better beam (or set of beams) to set up a directional (and fully beamformed) communication link. In the initial access, UE may perform beam pairing by creating mappings between SSB and PRACH.

Phase 2—Beam refinement for transmitter (gNB or TRP Tx): the gNB or TRP may refine beam (e.g., sweeping narrower beam over narrower range compared to phase 1) and the UE detects one or more best beams and report them to gNB or TRP (according to an aspect, in a serving cell, a gNB may have multiple TRPs). In RRC connected state, CSI-RS can be configured with no repetition thus UE can select and report the one or more finer beams.

Phase 3—Beam refinement for receiver (UE Rx): the gNB fixes a beam (transmit the same beam repeatedly) and the UE refines its receiver beam. The UE sets the spatial filter on receiver antenna array. This can be used for example for UEs with analog or hybrid beamforming implementations that need to perform beam sweeping in time to find the best receiver beam. In RRC connected state, CSI-RS can be configured with repetition thus it may be assumed UE to determine one or more finer beams accordingly.

In NR, the evaluation of the quality of the received beam may be based on different metrics such as RSRP, RSRQ and SINR.

### Multiple Transmission/Reception (M-TRP) in Rel-16

In NR Rel-16, enhanced MIMO includes support of multiple transmit receive point (M-TRP) transmission. In M-TRP transmission scheme, data may be transmitted from multiple TRPs for diversity to improve transmission reliability and robustness. For data scheduling via M-TRP, support for both single DCI and multiple DCIs for ideal backhaul and non-ideal backhaul are introduced in Rel-16, respectively. In single DCI based scheme, a DCI schedules PDSCH from multiple TRPs, e.g., one set of PDSCH layers from a first TRP and a second set of PDSCH layers from a second TRP. In multiple DCI based scheme, two TRPs can independently schedule PDSCHs from two TRPs.

### TRS/CSI-RS in RRC Idle/Inactive Mode UE

The configuration of tracking reference signal (TRS) and/or channel state information reference signal (CSI-RS) occasion(s) for RRC idle/inactive mode UE(s) provided by higher layer signalling has been agreed in Rel-17. One of the main purposes of introducing TRS/CSI-RS in idle/inactive mode UE is for better time/frequency tracking and automatic gain control (AGC) for the reception of paging channel. Besides, it is up to gNB implementation whether to transmit a TRS/CSI-RS. TRS/CSI-RS for intercell RRM measurement functionality (e.g., inter cell) is not supported for idle/inactive UE(s).

### Problem Statement

Beam Management for Idle/Inactive Mode UE for NR from 52.6 GHz and Above

For NR from 52.6 GHz and above, beam management needs to consider the impact of narrower beamwidths on UE in idle/inactive state, enhancements to beam management for random access procedure, small data transmission in RRC idle/inactive state, intra- and/or inter-cell mobility, and adaptation to LBT failures, etc.

### Multi-Beams Transmission and Indication for Single DCI Schedule Multi PDSCHs

In Rel-16, PDSCH reliability enhancements (e.g., PDSCH repetition and transmission from multiple TRPs) have been specified. PDSCH reliability enhancement can support different multiplexing schemes such as spatial division multiplexing (SDM), frequency domain multiplexing (FDM) and time domain multiplexing (TDM). In addition, In Rel-17, PDCCH reliability enhancements (e.g., PDCCH repetition and transmission from multiple TRPs) may be discussed. In Rel-17, PDCCH reliability enhancement can support PDCCH FDM, TDM and SFN scheme in which a single DMRS port is associated with two TCIs scheme. However, due to PDCCH processing limitation as a result of a shorter slot duration assuming the same UE processing capability per a given time unit, and narrower beams transmission and reception for NR from 52.6 GHz and above, the support of multiplexing schemes and TCI indications for PDSCH in Rel-16 and PDCCH reliability enhancement in Rel-17 may not directly apply to the single DCI scheduling of multiple PDSCHs for NR from 52.6 GHz above. For example, FDM requires processing two PDCCH candidates which may increase the PDCCH processing complexity per slot or TDM per span. SDM scheme for PDCCH needs to be introduced either based on single or two DMRS ports.

Rel-15/16 beam reporting framework has a limited capability to efficiently enable multi-beam high rank transmission in single/multi-TRP (M-TRP) or multiple panels (MP) environment. To achieve high rank transmission via either for M-TRP or MP transmission, it requires lower spatial correction among different beams or spatial information. UE may report the neighbor SSB ID since those neighbor SSB also given better L1-RSRP. Therefore, UE may report higher spatial correlation as report.

### Solutions

According to aspects, solutions to the problems discussed above are provided. The problem of design of NR from 52.6 GHz and above is considered, as well as other use cases that may experience similar issues or problems.

When the larger SCSs/numerologies are introduced for NR from 52.6 GHz and above, the slot duration in a subframe will be decreased accordingly. Since the slot size decreases linearly with the increased SCS, the number of CSI processing units per slot are expected to be decreased for higher SCSs/numerologies (e.g., SCS 480 KHz and 960 KHz, etc.) scenarios as shown in Error! Reference source not found.

TABLE 1
Possible supported numerologies, symbol, and slot duration
for NR from 52.6 GHz and above.

| Numerology | μ = 3 | μ = 4 | μ = 5 | μ = 6 |
|---|---|---|---|---|
| Subcarrier spacing (SCS) | 120 | 240 | 480 | 960 |
| [KHz] | | | | |
| Maximum FFT size | 4096 | 4096 | 4096 | 4096 |
| Maximum number of PRBs | 264 | 264 | 264 | 264 |
| Slot duration [us] | 125 | 62.5 | 31.25 | 15.625 |
| Normal cyclic prefix length | 585.94 | 292.97 | 146.48 | 73.24 |
| [ns] | | | | |
| Maximum allocation | 380.16 | 760.32 | 1520.64 | 3041.28 |
| bandwidth [MHz] | | | | |
| Maximum channel | 400 | 800 | 1600 | 3200 |
| bandwidth [MHz] | | | | |

### Beam Management for RRC Idle/Inactive State UE

Due to the reliance on highly directional links for NR operation from 52.6 GHz and above, the efficient beam management is a key to establishing and maintaining a reliable link. To establish a beam pairing between the transmitter and receiver, the transmitter and receiver both discover each other in the spatial domain before the data communication through the directional link(s). All possible combinations of the beam pairs of transmitter-receiver can be termed as the beamspace. For NR from 52.6 GHz and above, the increased number of antennas can make the beams narrower which increases the beamforming gain but also makes the size of the beamspace larger.

In Rel-15/16, synchronization signal block (SSB) is transmitted periodically by gNB (e.g., 20 ms) or transmission point (TRP) and the UE will determine the direction in the beam space where the incoming signal is stronger. SSB can be transmitted in a beam sweep from gNB/TRP which may require the receiver to search over beamspace by measuring the received power for every possible transmitter-receiver beam pair. In Rel-15/16, UE can start listening on the SSB with the wider SSB beams and step by step converges to the narrower beam via using CSI-RS in connected mode. This approach can be referred as a hierarchical beam search scenario.

In Rel-17, CSI-RS/TRS can be provided for idle/inactive mode UE. Introduction of TRS/CSI-RS in idle/inactive mode UE is for better time/frequency tracking and automatic gain control (AGC) for the reception of paging channel. In addition, there is a possibility that TRS/CSI-RS can be used as an early paging indication which may be discussed in Rel-17. In one aspect, beam management may be focused on using CSI-RS/TRS for idle/inactive mode UE especially for NR from 52.6 GHz and above. For 52.6 GHz and above frequency band, beam management for idle/inactive mode UE is in some way different from other frequency range band like frequency range 1 (FR1) and 2 (FR2). For example, introduction of larger SCSs and channel bandwidth are shown in Error! Reference source not found. for NR from 52.6 GHz and above. In practice, noise power increases by 3 dB when bandwidth doubles. In addition to penetration and reflection loss, signal and channel coverage are degraded when the higher SCSs/numerologies are introduced for NR 52.6 GHz and above if without any enhancement.

For higher frequency for 52.6 GHz and above, one solution for enhancement of the coverage and link budget is using narrower beam with increased or higher antenna gain. Therefore, narrower SSB beam for the introduced higher SCS (e.g., 960 KHz) may be expected for NR from 52.6 GHz and above. However, the use of narrower SSB beams under the assumption of not increasing number of SSBs may reduce the spatial coverage thus cover fewer UEs. Therefore, some enhanced beam management may be considered to account for the loss in the size of beam width and the resulting reduction in the coverage sector of a wider beam, and the increase in the number of narrow beams to compensate for the lost in sector coverage.

In one aspect, a method for enhancing idle/inactive mode UE coverage is to increase the maximum number of supported SSB in a synchronization burst from 64 defined in Rel-15/16 to a bigger number Lₘₐₓ (e.g., Lₘₐₓ=128) for larger SCS or numerologies (e.g., SCS≥960 KHz) in a half frame. However, this option may require changing the NR specification. For example, the SSB mapping in time domain for SCS=960 KHz is shown in Error! Reference source not found. In Error! Reference source not found. exemplary design, starting symbol of each SSB can be expressed as {m}+14n, where m is a constant (e.g., m=8) as the starting symbol offset and n=1, . . . ,128 or {m}+98n where m=8, 32, 48, 64 and n=1, . . . ,32. In this SSB exemplary design for higher SCS, there are Lₘₐₓ=128 SSB in a synchronization burst and the duration of each synchronization burst is within 2 or 4 ms. Each SSB transmit on a slot and the slot duration is equal to 15.625 μs when SCS is 960 KHz. Therefore, the duration of the SSB burst is within 2 or 4 ms when Lₘₐₓ=128. In addition, SSB index is indicated by 3 bits in DM-RS for PBCH and 4 bits are in MIB. The extra bit can use from the reserved bits in MIB to maintain the same bit payload e.g., 56 bits as other frequency range like FR1 and FR2. The synchronization burst set is always confined to a 5 ms window and is either located in first-half or in the second half of a 10 ms radio frame. The half-frame indicator (single bit) is indicated by the master system information (MIB). UE may assume the default periodicity of the synchronization burst is 20 ms. Each SSB in a synchronization burst is separated at least by more than the beam switching time (e.g., 70˜100 us). Besides, the value of the inOneGroup and groupPresence provided by higher layer parameters ssb-PositionsInBurst can be modified for this new introduced Lₘₐₓ. The network can still set the SSB periodicity for new introduced SCS via RRC parameter ssb-PeriodicityServingCell (e.g., 480, 960 KHz) which can take values in the range {5 ms, 10 ms, 20 ms, 40 ms, 80 ms, 160 ms}.

In one aspect, a method for enhancing idle/inactive mode UE spatial coverage uses TRS/CSI-RS for NR from 52.6 GHz and above. The maximum number of supported SSB L max defined in Rel-15/16 may not need to be augmented as shown in Error! Reference source not found. As shown in Error! Reference source not found. exemplary design, starting symbol of each SSB can be expressed as {m}+28n, where m is a constant (e.g., m=8) as the starting symbol offset and n=1, . . . ,64 or {m}+98n n=8, 48 and n=1, . . . ,32. Instead, TRS/CSI-RS can be allowed for idle/inactive mode UE for enhancement of the limited spatial coverage of each SSB beam. TRS/CSI-RS configuration (e.g., availability of CSI resource set, CSI resource, etc.) and the transmission occasion can be broadcast via system information block (SIB), e.g., SIB 1 or SIB 2, or can be when the UE was in RRC connected mode before it transiting to the RRC inactive mode, or can be based on a predefined table. TRS/CSI-RS transmission occasion may be configured to incorporate with the paging transmission occasion for reception enhancement, or it can be independently configured. The TRS/CSI-RS reception occasion may also be configured relative to the reception occasion of the RACH message 2 or the RACH message 2 part of the two step RACH message B.

If CSI-RS/TRS resources configuration are introduced for idle/inactive UEs for NR from 52.6 GHz and above, UE may need to handle more SCS combination for SSB, CORESET 0 and CSI-RS/TRS. Following exemplary combination of SSB, CORESET 0 and CSI-RS/TRS may appear:

For SSB SCS is equal to CORESET 0 SCS: {SSB, CORESET 0, CSI-RS/TRS}={120, 120, 120}, {480, 480, 480}, {960, 960, 960} kHz

For SSB SCS is not equal to CORESET 0 SCS: {SSB, CORESET 0, CSI-RS/TRS}={120, 480, 480} or {120, 960, 960} kHz

In practice, for NR-U operation from 52.6 GHz and above, single carrier and multiple carrier aggregation (CA) operation are under study. From Error! Reference source not found., larger SCS (e.g. 960 KHz) can be applied for NR-U single carrier operation and co-exist with a WiFi 802.11 ad/ay channel and smaller SCS like SCS 120 KHz can be applied for CA and co-exist with a WiFi 802.11 ad/ay channel. When CSI-RS/TRS is adopted for idle/inactive mode from 52.6 GHz and above, the aggregated SCells can be applied with the same beam which has been determined and identified by the PCell or PSCell.

In NR Rel-15/16, in idle/inactive mode the inter/intra frequency measurement is based on synchronization signal (SS), and in the connected mode it is additionally based on CSI-RS in DL and SRS in UL. The CSI-RS transmission configuration, e.g., periodicity and time offsets, are relative to an associated SSB burst. If the availability of TRS/CSI-RS at the configured occasion(s) is informed to the idle/inactive mode UE, then UE can perform the measurement (e.g., RSRP) for beam management at the idle/inactive mode. The CSI-RS/TRS transmission occasion for idle/inactive mode UE may have the following options: first option is CSI-RS/TRS transmission occasion is associated with a paging occasion and the second option is CSI-RS/TRS is not associated with paging transmission occasion (e.g., CSI-RS/TRS transmission occasion can be configured without considering PO).

CSI-RS/TRS Transmission Occasion is Associated with a Paging Occasion

The RRC idle/inactive mode UE is required to monitor one paging occasion per idle mode DRX (IDRX) cycle to detect the scheduling of paging and system information update. The paging occasion location is determined by the UE identity. In each IDRX cycle, the UE gets to stay in sleep mode (‘OFF’ duration) to conserve energy. However, the UE is expected to wake up for a specific sub-frame called the paging occasion (PO) to monitor the PDCCH for paging. If the PDCCH for paging is received in the PO, then the UE decodes the PDSCH to receive the paging message. If the page is not intended for the UE, it sleeps again till the next PO. Every IDRX cycle, the UE monitors only one PO in a specified paging frame (PF). In NR spatial/directional communications, the same paging message is to be transmitted over different/multiple beams. A PO can have multiple monitoring occasions (MO)s and each MO is QCLed with a specific SSB. An exemplary design of CSI-RS/TRS transmission with paging occasion is shown in Error! Reference source not found.A, 3B, and 3C. In Error! Reference source not found.A, 3B, and 3C, N SSBs are assumed in a synchronization burst (or a SSB burst) and a PO is with multiple MOs where each MO is QCLed with an SSB. In addition, M (e.g., M=1 or 2) CSI-RS/TRS resource sets can be associated with a MO.

In Error! Reference source not found.A, a single non-zero-power (NZP) CSI-RS/TRS (beam) is transmit within a MO and each CSI-RS/TRS is QCLed (e.g., QCL type A or D) with a SSB ID and the DM-RS port of the paging PDCCH and PDSCH. In Error! Reference source not found.B, multiple (e.g., a group of) CSI-RS resources or resource sets are configured and transmit within a MO in a PO but at least one TRS is QCL type A with the paging channel DM-RS, e.g., paging PDCCH and PDSCH. Each CSI-RS/TRS in the same group is QCLed type D with an SSB or a subbeam of SSB and each CSI-RS/TRS beam may be configured narrower than the SSB beam. UE can determine a refined beam narrower than the associated SSB beam when extra CSI-RSs are transmitted with paging channel. Note, in Error! Reference source not found.A and 3B cases, the paging channel overhead is not increased.-In Error! Reference source not found.C, multiple (or a group of) CSI-RS/TRS resources or CSI-RS/TRS resource sets are associated with multiple (or a group of) MOs and each CSI-RS/TRS resource or resource set is mapped to a MO. For example, as shown in Error! Reference source not found.C, it is assumed there are N (e.g., N=64) SSB in a synchronization burst (or SSB burst) and M (e.g., M=2) CSI-RS/TRS are QCLed with an SSB. Therefore, a hierarchical beam scenario can be formed, and fast beamspace/beam corresponding can be made for idle/inactive mode UE from 52.6 GHz and above. More specific, narrower (or sub-) beam of SSB beam can be applied for CSI-RS/TRS and UE is able to identify an SSB index and then identify which CSI-RS/TRS has better reception quality based on the measured metric (e.g., RSRP). As shown in Error! Reference source not found.C, QCL assumption still can be achieved between CSI-RS/TRS and SSB. CSI-RS/TRS are QCL type D with SSB and the paging channel e.g., paging PDCCH and PDSCH is QCL type A with CSI-RS/TRS.

In addition, paging PDSCH can be with the cross-slot scheduling. The cross-slot value K₀ can be either semi-statically configured by SIB or dynamically signaling via the field time domain resource allocation (TDRA) in paging PDCCH for NR from 52.6 GHz and above.

Unlike the CSI-RS has two operation modes in NR beam management for connected mode UE, e.g., CSI-RS is dependent on the ‘repetition’ flag is turn-on/off for beam management. The CSI-RS ‘repetition’ flag for idle/inactive mode UE can be default as off

When CSI-RS/TRS transmission is with a paging occasion, the availability of CSI-RS/TRS for idle/inactive mode UE can have the following options: first option is that the availability of CSI-RS/TRS is indicated by the legacy paging PDCCH. According to an aspect, gNB may use multiple TRPs for transmission of SSB and PO for covering different spatial directions. Therefore, a single bit is sufficient to enable and/or disable the CSI-RS/TRS for idle/inactive mode UE with a specific spatial direction or bit-mapping method can be applied to indicate the availability of CSI-RS/TRS. Hence, the legacy paging PDCCH can be reused without modifying the size of the paging DCI.

According to an aspect, the number of reserved bits can be from the five unused bits in the short message field plus 6 existing reserved bits in DCI format 1_0 scramble with P-RNTI as shown in Table 2. The second option is that legacy paging PDCCH carry the codepoint of activated CSI-RS/TRS identities. The third option is indicated via using group-common PDCCH (GC-PDCCH). In the second option, UE may need to monitor a GC-PDCCH before the paging PDCCH. The use case of GC-PDCCH is for early indication of paging channel. The third method is via higher layer signaling (e.g., SIB). The UE monitor the paging occasions (POs) to receive system information change notifications in RRC idle/inactive mode. When the short message notifies system information changes, then the UE should re-acquire the system information for the configuration of CSI-RS/TRS and the availability of CSI-RS/TRS. The availability of CSI-RS/TRS for RRC idle/inactive mode UE will be available at next coming idle/inactive mode DRX (I-DRX) cycle when UE detect the signaling for the availability of CSI-RS/TRS.

TABLE 2
DCI format 1_0 with CRC scrambled by P-RNTI

| DCI Field | Numbers of bits |
|---|---|
| Short message Indicator | 2 |
| Short Messages | 8 (only 3 bits are used, and 5 bits are |
| | unused), Note: the unused bits can be |
| | used for indication of the availability |
| | of CSI-RS/TRS |
| Frequency domain | log₂ (N_{RB}^{DL,BWP} (N_{RB}^{DL,BWP} + 1)/2) |
| resource assignment | |
| Time domain resource | 4 |
| assignment | |
| VRB-to-PRB mapping | 1 |
| Modulation and coding | 5 |
| scheme | |
| TB scaling | 2 |
| Reserved bits | 6 Note: the unused bits can be used |
| | for indication of the availability of |
| | CSI-RS/TRS |

CSI-RS/TRS transmission occasion is not associated with PO

Like the RRC connected mode UE, the time offset of CSI-RS/TRS transmission for idle/inactive mode UE can be relative to the associated SSB burst. The CSI-RS resources sets for connected UEs can also be configured for idle and inactive state UEs. The supported periodicities T_{CSI,slot} for the periodic CSI-RS transmissions can be based on number of slots e.g., {110, 20, 40, 80, 160, 320, 640}, etc. The CSI-RS/TRS configuration including the CSI resource, time/frequency offset, periodicity, etc. for idle/inactive mode UE can be the same as the connected mode CSI-RS/TRS configuration. The configuration of CSI-RS/TRS can be broadcast via the system information (e.g., SIB 1 or 2), or can be inherited from the RRC connected mode, or can be based on a predefined conditions. The availability of CSI-RS/TRS may not be informed to the idle/inactive UE. The network/gNB can determine the CSI-RS/TRS configuration and availability for idle/inactive mode UE and the spatial direction (e.g., QCL type D with a SSB index). For example, the network/gNB may configure up to M (e.g., M=2) CSI-RS/TRS resource sets with an associated SSB (e.g., QCL type D with the associated SSB). M CSI-RS/TRS transmission occasion can take up to N×M slots, here it may be assumed each CSI-RS/TRS is transmitted in a slot and N SSB. An exemplary design of CSI-RS/TRS transmission occasion is shown in Error! Reference source not found. In Error! Reference source not found., M (e.g., M=2) CSI-RS/TRS sub-beams are configured for each associated SSB in a CSI-RS/TRS transmission occasion.

The availability of CSI-RS/TRS are similar to the proposed methods for CSI-RS/TRS with a paging occasion, e.g., it can be signaled by paging DCI, GC-PDCCH (if available), and/or higher layer (e.g., SIB) for idle/inactive mode UE or inherited for connected mode. The availability of CSI-RS/TRS for idle/inactive mode UE will be available at next coming CSI-RS/TRS transmission occasion cycle or after a time duration when UE detect the signaling for the availability of CSI-RS/TRS.

TRS Transmission Occasion is Associated with PO but CSI-RS Transmission is not Associated with Paging Occasion

TRS is separated configured with the CSI-RS for idle/inactive state UE. The transmission of TRS is within a MO and TRS is QCLed type A with a SSB ID and the DM-RS port of paging PDCCH and PDSCH. The CSI-RS resources sets for connected UEs can also be configured for idle and inactive state UEs. The supported periodicities T_{CSI,slot} for the periodic CSI-RS transmissions can be based on number of slots e.g., {10, 20, 40, 80, 160, 320, 640}, etc. for idle/inactive state UE. In this approach, TRS is dedicated for enhancement of the reception of paging channel and the CSI-RS resource sets can be used for beam refinement for idle/inactive state UE. As shown in Error! Reference source not found., the network/gNB may configure a TRS for each MO in a PO and UE may assume the TRS is QCL type A with the DM-RS for the MO (e.g., paging PDCCH and PDSCH). In addition, the network/gNB may also configure multiple CSI-RS resource sets for idle/inactive state UE for beam refinement. The network/gNB can configure the QCL assumption (e.g., QCL type D) for multiple CSI-RS resource sets with a SSB index. For this proposed method, the paging overhead is not increased since each DM-RS for a MO is QCLed with a SSB ID.

Transmission of CSI-RS/TRS when LBT is Failure for Idle/Inactive State

For NR-U from 52.6 GHz and above, if the listen before talk (LBT) fail then CSI-RS/TRS transmission occasion for idle/inactive mode UE can be dropped. Furthermore, the following conditions are proposed for UE to determine whether to receive CSI-RS/TRS or not when LBT is failure.
If the UE does not receive the SSB that is QCLed with the CSI-RS/TRS when it is available, then UE may assume that LBT failed.
When CSI-RS/TRS is assumed transmitted with a MO and if the UE does not receive the paging channel (e.g., paging PDCCH and PDSCH) and the associated CSI-RS/TRS, then UE may assume LBT failure.
If the UE does not receive GC-PDCCH for CSI-RS/TRS IDs, then UE may assume LBT failure

### Beam Selection and Reporting for Idle/Inactive Mode UE

In Rel-15/16 idle/inactive mode, after the UE selected a SSB (beam) there is a predefined one or more RACH opportunities with certain time and frequency offset and direction (to this SSB only), so that the mobile terminal knows in which transmit (UL) beam to transmit the RACH preamble. This is a way for mobile terminal to notify the gNB which one is above the threshold in Rel-15/16. The UE will be indicated by network/gNB via the system information for the mapping between PRACH resource and SSB. In this way, there is a one-to-one mapping between SSBs and PRACH resource at the idle/inactive mode. The UE will send PRACH preamble in the UL corresponding to the SSB in which the signal strength above threshold is detected. When CSI-RS/TRS transmission occasion are available for RRC idle/inactive mode UE for beam management, the following methods are proposed for UE reporting the selected CSI-RS/TRS. The CSI-RS/TRS can be either based on explicit or implicit reporting methods when UE wants to transit from idle/inactive state to connected state:

Explicit CSI-RS/TRS report: the selected CSI-RS/TRS resource ID(s) are reported via Msg A PUSCH payload in two-step RACH or Msg 3 PUSCH payload in four-step RACH procedure If the availability of CSI-RS/TRS is informed for RRC idle/inactive mode UE and network/gNB request for CSI report, then UE can report the preferred CSI-RS/TRS(s) from the M (e.g., 2) configured CSI-RS/TRS. Network/gNB can determine the selected SSB from the PRACH preamble and the refined sub-beam from the CSI-RS/TRS resource ID(s). For example, UE can report either one or multiple sub-beam/CSI-RSs and/or other SSB ID/index (according to an apect, if UE is configured with multi-beams reports). Therefore, the fast beam selection and beam refinement can be achieved for idle/inactive mode UE. For four-step RACH procedure or fall back from two-step RACH to four-step RACH when UE receive the fallback RAR, UE may select or reselect the suitable beam and report the preferred CSI-RS/TRS associated with the SSB and/or other SSB index via Msg 3 PUSCH.

Implicit CSI-RS/TRS report: the selected CSI-RS/TRS resource ID are mapped to a RACH preamble in a RACH transmission occasion (RO) associated with a SSB. The M CSI-RS/TRS(s) is/are sub-beams of a SSB and the PRACH preamble that the UE use when performing random access upon selecting the candidate beams identified by this SSB ID and CSI-RS/TRS resource ID if CSI-RS/TRS is available. When CSI-RS/TRS is not available for idle/inactive mode UE, the PRACH preamble is based on the selected SSB (SSB ID) as Rel-15/16. The available number of contention-based preambles Q (e.g., Q=64 preambles) per SSB can be indicated by system information (e.g., CB-PreamblesPerSSB). For NR from 52.6 GHz and above, fewer UEs are covered by the same beam due to the narrower beam width. Therefore, number of available PRACH preamble per SSB is sufficient for mapping of SSB and CSI-RS/TRS ID. More specific, the number of available RACH preamble Q per SSB can be partitioned with

$$⌊ \frac{Q}{M} ⌋$$

groups, where M is the number of CSI-RS/TRS (sub-beams) per SSB. In each preamble group, there are M preambles, and each preamble is mapped to a CSI-RS/TRS ID. An exemplary design of implicit CSI-RS/TRS report for idle/inactive mode UE is shown in Error! Reference source not found. In Error! Reference source not found., it is assumed each PRACH transmission occasion (RO) is mapped to a SSB (e.g., ssb-perRACH-Occasion=1) and two ROs are frequency multiplexing (FDM) in a same time resource (e.g., msg1-FDM=2). M (e.g., =2) sub-beams are QCL with each SSB. Therefore, Q=64 preambles per RO and Q preambles are further partitioned as

$$\frac{Q}{M = 2} = 32$$

preamble groups in a RO. UE can select a preamble in a preamble group to indicate the selected CSI-RS/TRS.

Support of CSI-RS/TRS for RRC idle/inactive mode UE can have several advantages for NR from 52.6 GHz and above. The transmission or reception of new data to/from a UE in RRC idle state requires the establishment of an RRC connection. After RRC connection establishment, the UE transits to RRC connected state and the network/gNB can allocate radio resources thus the UE can consequently send or receive data packets. If the refined beam can be achieved right after the RRC connection or reconnection, UE can receive the data with a refined beam thus the reception performance and latency can be further improved. Furthermore, when CSI-RS/TRSs are provided for idle/inactive mode UE, the network/gNB can set up with fewer CSI-RS/TRS (e.g., avoid the excessive beam sweeping for a UE or few UEs) with the configured parameter ‘repetition’ ON for UE identifying or training the receiving beam (e.g., the phase 3 beam training) right after UE enters the connected mode. Therefore, faster beam training can be achieved compared to the current NR beam training scheme.

If NR-U UE initial a RACH transmission for UL data transmission while UE is in idle/inactive state, then gNB or network can treat the Msg A for two-step RACH or Msg 1 for four-step RACH as an indication of ready to send (RTS) CSI-RS/TRS

Small Data Transmission with CSI-RS/TRS for Idle/Inactive Mode UE

If the UE is in idle/inactive state DRX, it will listen to the network/gNB periodically. In this case, the network can send a paging message (e.g., paging PDSCH) to notify there is pending downlink traffic for the UE. After the UE successfully receive the paging message, the UE initiates the scheduling request (SR) procedure. Therefore, when CSI-RS/TRS is available for idle/inactive state UE, the UE may be benefit for better reception of paging channel and transmission of PRACH channel (e.g., including MsgA for 2-step RACH or Msg 1 and Msg 3 for 4-step RACH) for transition to RRC connected state. The proposed methods of configuration of CSI-RS/TRS resource sets shown in Error! Reference source not found.A/3B/3C, Error! Reference source not found., and Error! Reference source not found. are applicable for small data transmission procedure. However, if the UE is using power saving mode (PSM), the network may not be unreachable until the UE initiates either a UL transmission for transition to RRC connected state or the timing area update (TAU) procedure. If CSI-RS/TRS is available for idle/inactive state UE, the UE may be able to determine the better spatial information thus the network/gNB establish user plane bearers and AS security setup as for SR with better performance.

Due to narrower beams for NR from 52 GHz and above, fewer UEs share a same narrower beam. Besides, the bandwidth can be wider than FR1 and FR2. For example, the supported BW may be starting from 400 MHz for SCS=120 KHz. In this case, the PRB is 264 RBs. The supported BW is relative wider than FR1 and FR2. Therefore, the initial bandwidth part (BWP) may be equal to or inside of the default BWP configured by RRC. Therefore, the configured CSI-RS/TRS for idle/inactive mode UE can be shared with the RRC connected mode UE without considering BWP switching. The configuration of CSI-RS/TRS can be shared for both RRC idle/inactive and RRC connected mode UE, hence, the CSI-RS/TRS resource overhead can be reduced from the perspective of network/gNB and UE because UE may stay at the default BWP for power saving most of time for connected mode UE and stay at initial BWP for idle/inactive mode UE.

Multi-Beam Transmission and Indication for Single DCI Schedule Multi PDSCHs from Multiple Transmission Points (M-TRPs)

There are several advantages to reduce the number of PDCCH candidates or blind decoding (BD) efforts for NR from 52.6 GHz and above. A first reason is to reduce PDCCH blocking probability and enhance the scheduling flexibility. This is because that PDCCH can be transmitted in the nearest CORESET after the arrival of data. A second reason is to reduce the decoding complexity and potentially save UE power consumption. Here, we propose a single DCI can schedule multiple PDSCHs from M-TRPs. The scheduled PDSCHs from M-TRPs can be based on SFN, SDM, FDM and TDM from M-TRPs. A single DCI scheduling multiple PDSCHs based on SDM or SFN is shown in Error! Reference source not found.A. In Error! Reference source not found.A, a single DCI based on SDM or SFN is used to schedule multiple (e.g., two) PDSCHs and the PDCCH monitoring rate/frequency is assumed to be 2 slots. When single DCI schedule multiples PDSCH, the PDCCH monitoring rate/frequency can be reduced, thus it can reduce PDCCH decoding complexity and efforts for a UE. In addition, multi-beams (TCI) indication for both PDCCH and PDSCH are specified for different multiplexing schemes and/or deployment scenarios. For example, a single DCI can schedule repetition of PDSCH for ideal backhaul with time domain multiplexing (TDM) in Rel-16 for M-TRP transmission scheme. Like Rel-16 M-TRP transmission scheme, two or more TCIs can be indicated for the scheduling of a PDSCH and its one or more subsequent retransmission via a single PDCCH. In Rel-16, TCI state for PDCCH is from one of TRP (according to an aspect, the TCI state is with the corresponding CORESET) and multiple (e.g., two) scheduled PDSCHs are from multiple (e.g., two) different TRPs and each TCI state is indicated by the TCI filed in DCI/PDCCH. Another exemplary single DCI schedule multiple PDSCHs from M-TRP and the schedule multiple PDSCHs are based on TDM is shown in Error! Reference source not found.B. As shown in Error! Reference source not found.B, the repetition of multiple PDSCHs (e.g. PDSCH 1 and 2) are transmitted from another TRP (e.g. TRP 2).

The following exemplary methods provide reliability enhancement and multi-beam indication methods for a single DCI schedule multiple PDSCHs based on SFN with M-TRP transmission for NR from 52.6 GHz and above:

To enhance PDCCH monitoring frequency and reduce the decoding complexity, each TRP transmits the same DCI/PDCCH on the same time and frequency resource with the same DMRS port for a CORESET as shown in Error! Reference source not found.A. To be more specific, when DCI/PDCCH is transmitted on the same time and frequency resource(s), it can be treated as a special case of SDM (resource are totally overlapped) because traditionally, each TRP can transmit different data when SFN (a special case of SDM) is applied. In this manner, the number of PDCCH candidates and number of PDCCH channel estimation per slot or per span will not increase as well if the scrambling code for PDCCH DMRS (e.g., Cᵢₙᵢₜ) is used for the same PDCCH DMRS port (e.g., antenna port p=1000). For SDM. TDM or FDM based scheduled PDSCHs, two different demodulation reference signal (DM-RS) ports are required, i.e., one DMRS port is from TRP 1 and the other DM-RS port is from the other TRP (e.g. TRP 2). For uplink PUCCH Ack/Nack (A/N) transmission, the A/N of scheduled the multiple PDSCHs can be either based on joint A/N transmission to a TRP (e.g. TRP 1), i.e., A/N of PDSCH 1 and 2 are jointly transmitted on a PUCCH format. The TCI state of the PUCCH can be indicated by the DCI TCI field even for SFN scheme, i.e., a CORESET may associated multiple (e.g. 2) TCI states. In this case, UE may select the 1^{st} indicated TCI state in the DCI for the spatial reference for the A/N PUCCH transmission.

In Rel-15/16, PDCCH is only associated with one TCI/beam being used at a time. Therefore, if multiple TCI states are configured for a CORESET, the gNB activates one of the TCI states which is applied for the CORESET via a medium access control (MAC) control element (CE) activation command. In Rel-15/16, Each TCI state is either associated with one or two SSB and/or CSI-RS ID. Although UE can perform PDCCH channel estimation based on the effective channel when single frequency network (SFN) scheme (e.g., each TRP transmits the same DCI/PDCCH on the same time and frequency resource with the same DMRS port for a CORESET is supported for PDCCH reliability enhancement with multiple TRPs transmission. For clarification, UE still can handle the channel estimation like the single TCI case when the same DMRS port is associated with two TCIs state. The UE may have different approaches for reception of PDCCH, channel estimation and demodulation. For example, if a UE is equipped with multiple (e.g., two) panels (MP UE) for reception of PDCCH, then UE may use each panel for a corresponding TCI state (e.g., beam/spatial filter) and then combine them to obtain an effective channel estimator for channel estimation. The other reception approach is that UE can treat SFN scheme as a single TCI state and calculate the effective channel even with a single panel. Enabling multiple TCI states indication for PDCCH reliability enhancement in a CORESET, a method is to extend the MAC-CE contents from one TCI state to multiple (e.g., two) TCI states. However, if enabling multiple TCI states via DCI (e.g., format 1_1, 1_2 or a new DCI format) for PDCCH reliability enhancement in a CORESET for NR from 52.6 GHz and above, then the DCI indication method needs to be efficient to avoid excessive DCI size especially when DCI schedules multiple PDSCHs. The following methods are proposed for multiple TCI states enabling via using DCI:

Option 1: Multiple TCI states indication for PDCCH and PDSCHs through TCI indication field in DCI format (e.g., DCI format 1_1 or a new DCI format 1_x). The gNB may indicate one of the activated TCI states for a PDSCH via the TCI field included in a DCI format (e.g., 1_1 or new DCI format 1_x), which is scheduling the PDSCH. The higher layer (e.g., RRC or MAC-CE) can be configured to indicate both PDCCH and PDSCH using the same QCL information and set tci-PresentInDCI as “enable”. When UE receives the DCI format which indicates TCI states for PDSCH, UE can assume PDCCH (e.g., using the monitor PDCCH in the lowest CORESET ID) is with the same QCL information of PDSCH. Here, aspects may extend timeDurationForQCL for PDSCH defined in Rel-15/16 also applicable to PDCCH as well. The UE may assume that the DM-RS ports of PDSCH and DM-RS port of PDCCH of a serving cell are QCLed with the RS(s) in the TCI state with respect to the QCL type parameter(s) given by the indicated TCI state in DCI if the time offset between the reception of the DL DCI and the corresponding PDSCH is equal to or greater than a threshold timeDurationForQCL. If the time offset between the reception of the DL DCI and the corresponding PDSCH is less than the threshold timeDurationForQCL, then the UE may assume the DM-RS ports of PDSCH are QCLed type A or D with the DM-RS of the current received DCI or current TCI state. If TCI state indication from DCI for PDSCH also extended to PDCCH, then the initial TCI state for the PDCCH can be assumed QCLed with a SSB ID. The single DCI format size for scheduling multiple PDSCHs will not be increased when TCI field in DCI is used for the indication of PDCCH and PDSCH QCL spatial information (note: the QCL assumption can be either based on Type-A or Type-D). For a single DCI scheduling multiple PDSCH(s) with multiple TRP transmission, if a UE receive multiple (e.g., 2) TCI states which indicates M-TRP transmission then the first TCI state map for PDCCH and PDSCH transmitted from TRP 1, the 2nd TCI state map for PDCCH and PDSCH transmitted from TRP 2 and so on. For example, DCI updates TCI state and new TCI states are effective after timeDurationForQCL as shown in Error! Reference source not found.

Option 2: Separated TCI indication fields for PDCCH and the scheduled multiple PDSCH in single DCI scheduling multiple PDSCHs (e.g., multi-PDSCH scheduled by one DCI). PDCCH TCI field in DCI format can be like the TCI state indication for PDSCH. For example, there is a maximum of M (e.g., M=8 or 16) activated TCI states are mapped to a list of so-called codepoints. The gNB may indicate one of the activated TCI states for PDCCH via the TCI field in the DCI format which can schedule multiple PDSCH. To further save the overhead, the TCI states for PDSCH can be set as the subbeams of PDCCH. For example, the RS in the PDSCH TCI state is QCL (e.g., typeD and/or typeC) with RS in the PDCCH TCI state, or PDCCH is QCL with SSB and PDSCH is QCL with a CSI-RS. In practice, beam for PDSCH can be narrower than PDCCH and it can be treated as a subbeam of PDCCH. Therefore, PDSCH TCI state ID can be derived from PDCCH TCI state ID for further reducing the signaling overhead. The TCI state field for PDCCH TCI indication may take up to Q (e.g., Q=3) bits in DCI format. Aspects propose PDSCH TCI indication may use less than Q bits when the PDSCH TCI state can be derived from PDCCH when PDSCH is the subbeam (or sub-TCI state) of PDCCH. For example, as shown in Error! Reference source not found., a PDCCH TCI state ID is indicated by PDCCH TCI field in a DCI format 1_x with Q₁ bits (e.g., Q₁=3) and a PDSCH state ID is indicated by PDSCH TCI filed in DCI format 1_x with Q₂ bits (e.g., Q₂=1). In the exemplary design shown in Error! Reference source not found., the PDSCH TCI state ID can derived from both PDCCH TCI fields. For example, TCI state ID indicated by PDCCH is equal to a value z and the TCI state ID can be determined by z and z₁ where z₁ is indicated by TCI field for PDSCH in DCI format.

TABLE 3
An exemplary of new DCI format for NR from
52.6 GHz and above.

| | Bit size of Format 1_x |
|---|---|
| DCI fields of Format 1_x | (bits) |
| Identifier for DCI formats | 1 |
| Carrier indicator | 0 or 3 |
| Bandwidth part indicator | 0 or 2 |
| . | . |
| . | . |
| . | . |
| Antenna port(s) | 4, 5, or 6 |
| Transmission configuration | 0 or Q₁ (e,g, Q₁ = 3) |
| indication (TCI) for PDCCH | |
| Transmission configuration | 0 or Q₂ (e,g, Q₂ = 1) |
| indication (TCI) for PDSCH | |
| . | . |
| . | . |
| . | . |
| CRC | 24 |

Enhanced CSI-RS for Multi-Beams for NR Unlicensed Band from 52.6 GHz and Above

To enable multi-beams or beam refinement for PDCCH and/or PDSCH, the network/gNB may configure periodical CSI-RS (P-CSI-RS), semi-persistent CSI-RS (SP-CSI-RS) reports for connected mode UE. For NR unlicensed operation, P-CSI-RS or SP-CSI-RS may not be transmitted due to LBT result or has limitation on transmission because the time synchronization and beam forming frames transmissions cannot exceed certain amount (e.g., 10%) within a period of time (e.g., 10 ms). In addition, beam management may take certain of time for beam diversity (multi-beams) or refinement. Therefore, the network/gNB may trigger AP-CSI-RS for beam management especially for NR unlicensed (NR-U) operation from 52.6 GHz and above. Aspects propose the following methods for enabling the multi-beam when single DCI schedules multiple PDSCHs for NR-U from 52.6 and above.

When the network/gNB transmit a GC-PDCCH (e.g., format 2_0) to indicate the availability of COT or LBT results, UE can assume the COT information indicated by a GC-PDCCH as an implication of ready to send (RTS).

If AP-CSI-RS report(s) is/are triggered by network/gNB during a COT and the QCL information of the triggered AP-CSI-RS(s) is/are same with QCL information of the DL link(s) for a UE, then the UE may assume those AP-CSI-RS reports as an implicit indication of polling for clear to send (CTS). The resource set configuration of the triggered AP-CSI-RS reports can base on non-zero-power CSI-RS (NZP-CSI-RS), CSI-IM (e.g., NZP-CSI-RS+ZP-CSI-RS), or ZP-CSI-RS. According to an apect, NZP-CSI-RS and CSI-IM resource configurations are supported in Rel-15/16. The AP-CSI-RS reports can be based on signal-to-interference ratio (SINR) or the received signal strength or received signal energy level. The result of SINR can be treated as kind of indication of channel being clear or not. If AP-CSI-RS resource set configuration is based on ZP-CSI-RS then the measured received signal strength can be used for AP-CSI-RS report. According to an apect, the automatic control (AGC) is stable for those AP-CSI-RS antenna port(s) QCLed with the DL link for reception. Hence, ZP-CSI-RS can be configured for AP-CSI-RS with a ZP-CSI-RS resource set and ZP-CSI-RS can take up to x symbols, where x is dependent on numerology/SCS. For example, the duration of x symbols is greater than y (e.g., y=4) μs. When UE is triggered with AP-CSI-RS with ZP-CSI-RS resource set, the CSI reportQuantity can be set as the value ‘csi-RSS’, where ‘csi-RSS’ denotes for received signal strength in dBm. The CSI reportQuantity can be like layer 1 ‘csi-RSRP’ report which is a quantitated value with z dB (e.g., z=1) resolution. The CSI report priority value for triggered AP-CSI-RS in a COT can be set to higher priority value. For example, it can be set to the same priority as CSI report via PUCCH. The AP-CSI-RS report(s) on PUSCH is/are not required to multiplex with uplink data from the UE. However, if there is uplink data needs to be sent then AP-CSI-RS report(s) reports can be sent with the UL data. For NR from 52.6 GHz and above, a UE is not expected to receive more than one aperiodic CSI report request for transmission in a slot or a span where a span is equal to x slots, x can be configured via RRC parameter. The CSI feedback consists of a single part for ‘csi-RSS’ like ‘csi-RSRP’.

The network/gNB may trigger AP-CSI-RS for beam refinement and/or for exploring multi-beams (e.g., for beam management, beam failure detection and recovery) without LBT in the frequency band where LBT is required for connected mode UEs. The triggering of AP-CSI-RS may be outside of COT window. When a DCI (e.g., DCI format 0_1 or 0_2) triggers multiple CSI reports (e.g., L1-SINR, L1-RSRP reports) and the triggering time is outside of COT, UE may assume the triggered AP-CSI-RS reports is/are for beam training. The CSI resource sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). The network/gNB determines the TCI states to add or modify from the reports of the recipient UEs for multi-beams PDCCH/PDSCH transmission. For NR from 52.6 GHz and above, multiple AP-CSI-RS reports can be jointly reported via a PUSCH. The number of CSI report (e.g., Nᵣₑₚ) can be set as x (e.g., x=2), e.g., update for the x TCI states per PUSCH. The AP-CSI-RS report(s) on PUSCH is/are not required to multiplex with uplink data from the UE. In addition, the higher layer parameter reportQuantity is configured with one of the values ‘cri-RSRP’ or ‘ssb-Index-RSRP’ and the CSI feedback consists of a single part. The CSI feedback via PUSCH can be transmitted without LBT.

The network/gNB may modify TCI states for UE after receiving AP-CSI-RS or SP-CSI-RS or P-CSI-RS feedback from the (connected mode) UE. For NR-U with LBT, UE monitor GC-PDCCH (DCI format 2.0) for COT and subband (or component carriers) LBT. In practice, the COT duration may vary from 10 ms to 100 ms. Therefore, triggering of AP-CSI-RS reports during COT may take certain percentage of resources. To avoid the transmission of reference signals in a period exceed a certain percentage especially for a COT, there is a necessarily to support TCI state modification outside of COT. Therefore, DCI update TCI states for PDCCH which can be supported outside or inside of COT. When the TCI update occurs inside of COT, either through MAC-CE or DCI format (e.g., format 1_x) for PDCCH. For outside of COT, a DCI format (e.g., format 0_x) can be supported for updating PDCCH TCI states and the DCI format does not require to schedule DL or UL data transmission when it is outside of COT. Instead, it can schedule a PUCCH for ACK/NACK and it can be transmitted without LBT.

SFN scheme (e.g., single DMRS ports associated with two TCI states and transmit same signal/channel at the same time and over the same frequency channel to UE) can be supported for single DCI schedule multiple PDSCHs. More specific, single DCI support can support SFN scheme like PDCCH reliability enhancement. In this manner, a single DCI schedule multiple PDSCHs where the DMRS port for PDSCH can be associated with multiple (e.g., two) TCIs. If a DCI schedule multiple PDSCHs with joint A/N feedback, the joint feedback transmission slot for A/N can start from the last scheduled PDSCH slots with the K₂ value.

The proposed procedure for updating TCI states for NR-U from 52.6 GHz and above is summarized in Error! Reference source not found.

### Enhanced CSI Report Quantity for Multi-Beams

Rel-15/16 beam reporting framework has a limited capability to efficiently enable multi-beam high rank transmission in single/multi-TRP environment. NR reportQuantity support L1-RSRP related quantities (e.g., L1-SINR) in Rel-15/16. In L1-RSRP related quantities, UE reports the best M L1-RSRP. The number of reports is dependent on the configuration of groupBasedBeamReporting and nrofReportedRS parameter setup in Rel-15/16. However, the selected beam that maximizes link SNR or RSRP may not guarantee the optimal beam diversity because UE most likely select the best M reports from the neighbor beams or sub-beams. To ensure to achieve the better beam diversity from the CSI reports, aspects propose a new CSI report quantity that is based on L1-RSRP/L1-SINR with considering the spatial direction. More specific, UE can select the best M reports based on the L1-RSRP/L1-SINR quantity and angle of arrival (AOA) pattern or spatial information throughout the beam training procedure e.g., from the resource sets in AP-CSI-RS, P-CSI-RS and SP-CSI-RS. For example, four P-CSI-RS are configured for a UE and two CSI-RS with ID 1 and 2 are from TRP1 and the other two CSI-RS are from TRP2 with ID 11 and 12. If number of ‘csi-RSRP’ reports is configured to 2 for this example, then a UE most likely either selects the two beams from a TRP, e.g., either from TRP1 or TRP2. One of a solution is to increase the number of CSI reports from two to four for this example. However, this solution still cannot guarantee that UE report the best beam diversity when larger number of CSI-RS/SSB and narrower beam of CSI-RS/SSB are configured for NR from 52.6 GHz and above. A new CSI report quantity ‘csi-RSRP-diversity’ or ‘csi-SINR-diversity’ can be added into NR reportQuantity for distinguish with ‘csi-RSRP’ or ‘csi-SINR’. To ensure that UE reports the better beam diversity for multi-beam indications, the CSI report with ‘csi-RSRP-diversity’ or ‘csi-SINR-diversity’ can be based on the following procedures:

First, UE select the best L1-RSRP or L1-SINR (according to an apect, CSI report based on L1-RSRP or L1-SINR is dependent on the CSI report configuration) from the configured CSI resource sets. The configured CSI resource sets can associate with different CSI transmission type like P-CSI-RS, SP-CSI-RS or AP-CSI-RS.

Second, UE select the next best L1-RSRP/L1-SINR with a separated spatial information (e.g., the AOA or beam direction information) exceeding a threshold from the first selected resource set. The selected threshold can be on based on a pre-defined parameter or given from RRC parameter. For example, if the next best L1-RSRP/L1-SINR of a CSI-RS resource set and its spatial information (e.g., AOA) is less than a threshold compared with the best L1-RSRP/L1-SINR of a CSI-RS resource set then UE can skip selecting this resource set for reporting and pursue the next best L1-RSRP/L1-SINR of a CSI-RS resource set from the configured CSI resource sets. In this way, the diversity gain from CSI reports can be guaranteed. UE can continue select the next resource set with the proposed condition until the nrofReportedRS (e.g., M) is meet. In this manner, the proposed method guarantees to rendezvous with the better spatial diversity with DL reference signals.

Like Rel-15/16, if the UE is configured with the higher layer parameter groupBasedBeamReporting set to ‘disabled’ and reportQuantity=‘csi-RSRP-diversity’ then the UE is not required to update measurements for more than x (e.g., x=64) CSI-RS and/or SSB resources, and the UE shall report in a single report nrofReportedRS (higher layer configured) different CRI or SSBRI for each report setting. If the UE is configured with the higher layer parameter groupBasedBeamReporting set to ‘enabled’, the UE is not required to update measurements for more than x (e.g. x=64) CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple parallel simultaneous spatial domains receive filters.

### Timing Advance Value Setting Methods for Larger SCS

To support PUCCH transmission with large SCS (e.g. SCS=960 KHz) for NR from 52.6 GHz and above, the timing advance value can be set independently via MAC-CE for those CORESETs associated with different CORESET pool indices. For example, if a CORESET x configured with larger SCS (e.g. SCS>=960 KHz) associated with a CORESET pool index 0 and a CORESET y configured with larger SCS (e.g. SCS>=960 KHz) associated with a CORESET pool index 1, then the timing advance value for the PUCCH transmission with larger SCS which its spatial information refers to the CORESET x associated with the CORESET pool index 0 can be set different than the timing advance value for PUCCH transmission which its spatial information refer to the CORESET y associated with the CORESET pool index 1.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

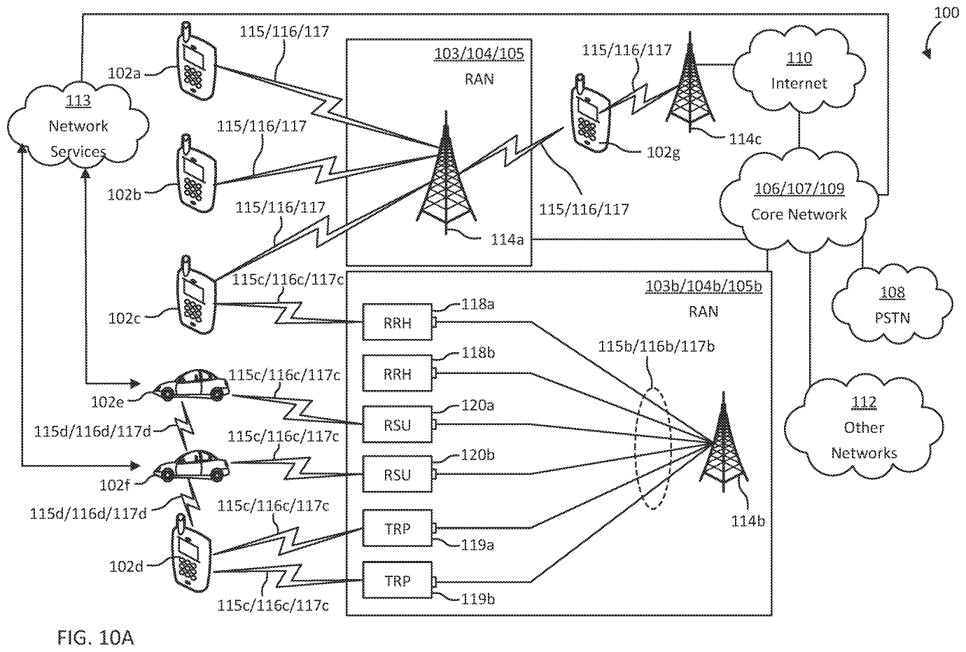

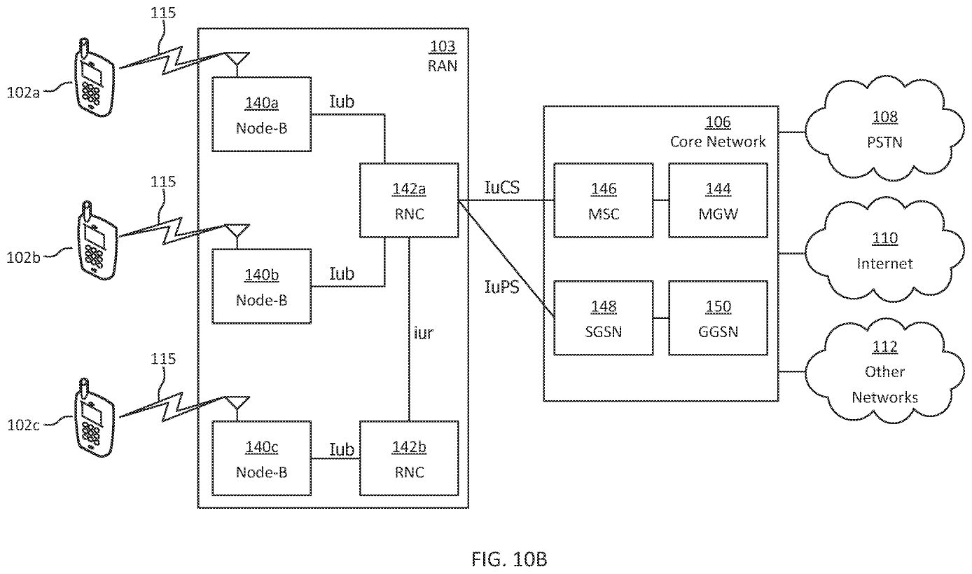

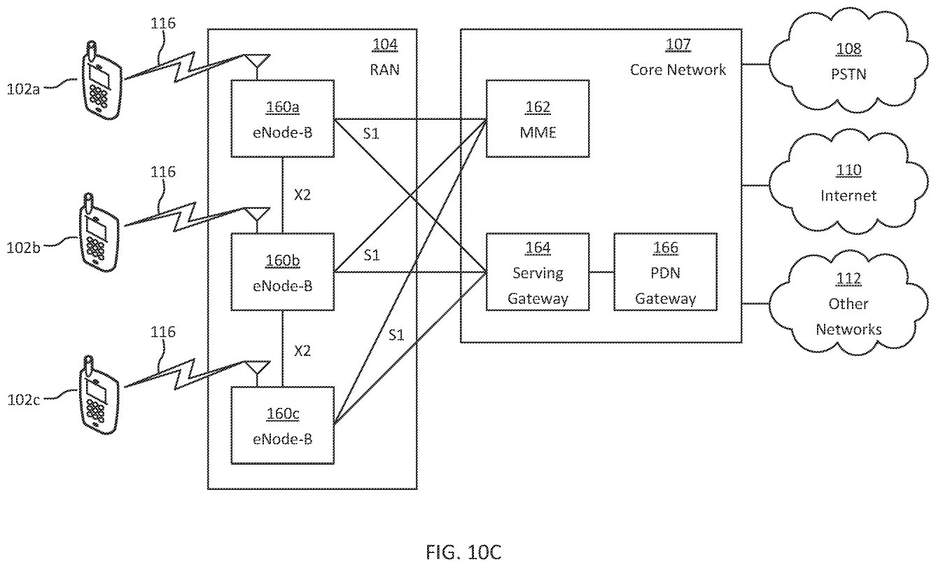

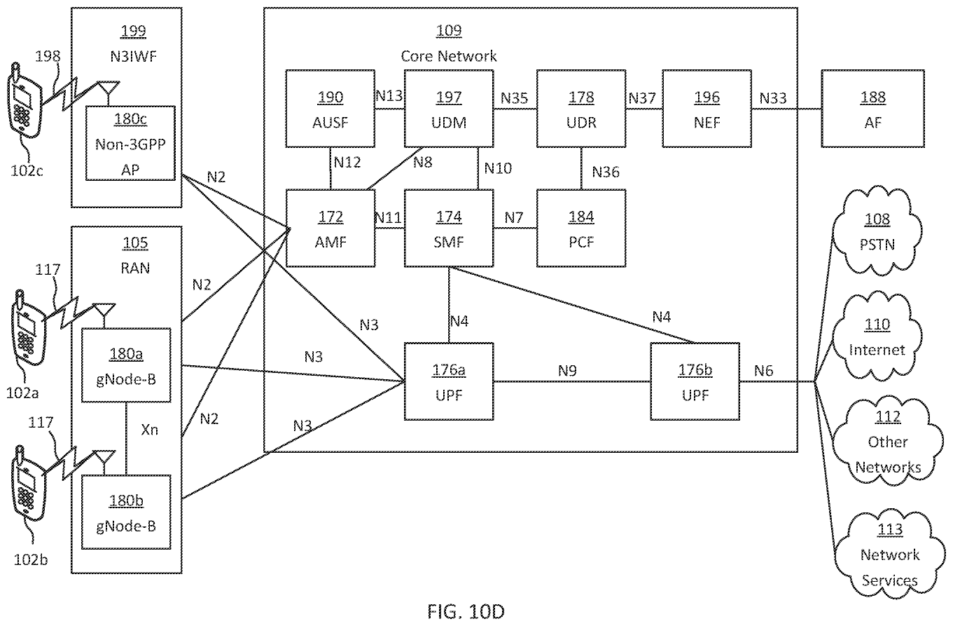

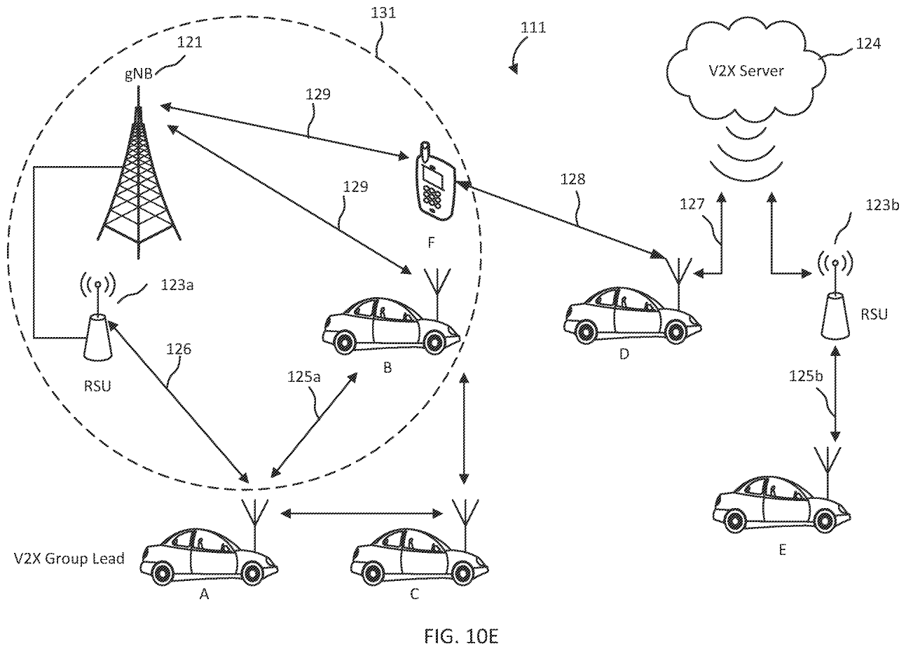

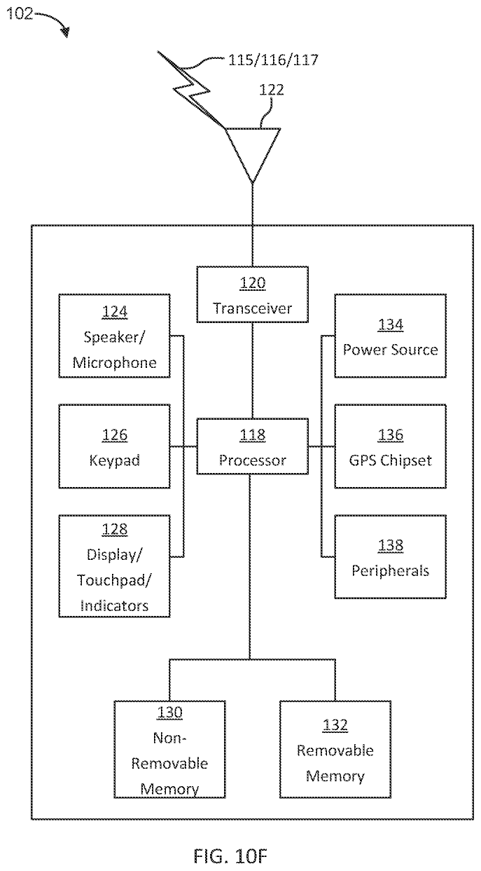

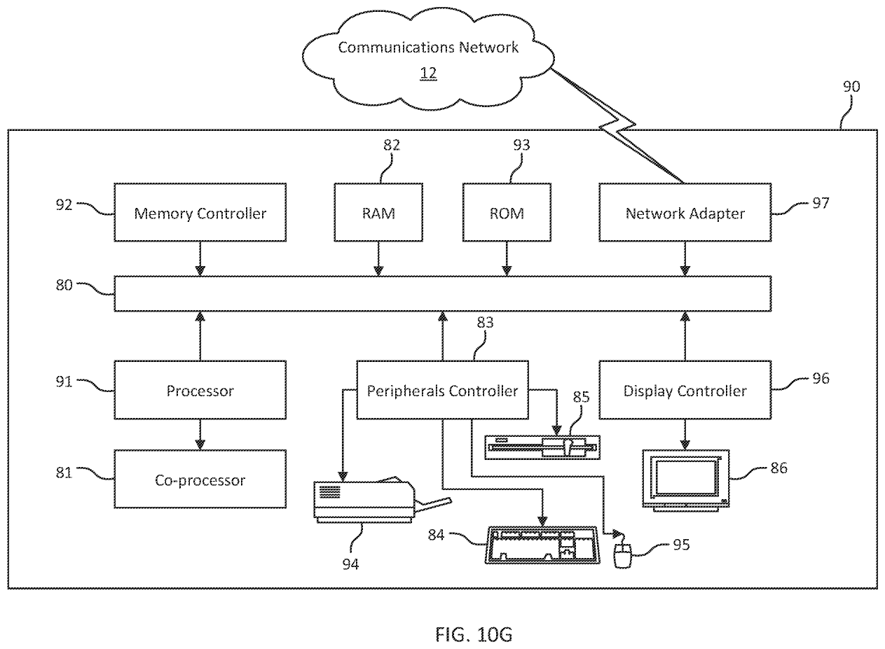

FIG. 10A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 10A, each of the WTRUs 102 is depicted in FIGS. 10A-10E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 10A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 10A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 10A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 10A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 10A may be configured to communicate with the base station 114a, which may employ a cellular-based radio technology, and with the base station 114c, which may employ an IEEE 802 radio technology.

Although not shown in FIG. 10A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 10B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 10B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 10B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Tub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 10B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 10C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 10C, the eNode-Bs 160a, 160b, and 160c may communicate with one another over an X2 interface.

The core network 107 shown in FIG. 10C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 10D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 10D, the gNode-Bs 180a and 180b may communicate with one another over an Xn interface, for example.

The core network 109 shown in FIG. 10D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 10G.

In the example of FIG. 10D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 10D shows that network functions directly connect to one another, however, it should be appreciated that they may communicate via routing agents such as a diameter routing agent or message buses.

In the example of FIG. 10D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 10D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 10D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 10D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 10A, 10D, and 10E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 10A, 10B, 10D, and 10E are provided by way of example only, and it is understood that the subject matter disclosed and claimed herein may be embodied or implemented in any similar communication system, whether presently defined or defined in the future.

FIG. 10E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 10E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 10E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 10F is a block diagram of an example apparatus or device WTRU 102 that may be configured for wireless communications and operations in accordance with the systems, methods, and apparatuses described herein, such as a WTRU 102 of FIG. 10A, 10B, 10C, 10D, or 10E. As shown in FIG. 10F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 10F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 10F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 10A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 10F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 10G is a block diagram of an exemplary computing system 90 in which one or more apparatuses of the communications networks illustrated in FIGS. 10A, 10D and 10E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 10A, 10B, 10C, 10D, and 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. A method of enhancing spatial coverage for user equipment (UE) for 5G New Radio (NR) from 52.6 GHz and above, the method comprising:
receiving, by the UE, a plurality of Transmission Configuration Indication (TCI) states, wherein each of the TCI states corresponds to a Physical Downlink Control Channel (PDCCH) or a plurality of scheduled Physical Downlink Shared Data Channel (PDSCH); and
determining, by the UE, a channel estimator for channel estimation by combining each of the TCI states.

2. The method of claim 1, wherein the plurality of TCI states are received for a multi-Transmission and Reception Point (TRP) environment.

3. The method of claim 1, wherein both the PDCCH and the plurality of scheduled PDSCH are indicated using the same Quasi-CoLocation (QCL) information.

4. The method of claim 1, wherein the TCI states are indicated in a Downlink Control Information (DCI) format.

5. The method of claim 1, further comprising determining, by the UE based on a time offset between a reception of a downlink (DL) Downlink Control Information (DCI) and a corresponding PDSCH being equal to or greater than a threshold, a first Division Multiplexing Reference Signal (DM-RS) port of the PDSCH and a second Division Multiplexing Reference Signal (DM-RS) port of the PDCCH of a serving cell are Quasi-CoLocationed with one or more reference signals (RSs) in the plurality of TCI states.

6. The method of claim 1, further comprising determining, by the UE based on a time offset between a reception of a downlink (DL) Downlink Control Information (DCI) and a corresponding PDSCH being less than a threshold, DM-RS ports of PDSCH are quasi co-located (QCLed) with the DM-RS of the current received DCI or a current Transmission Configuration Indication (TCI) state.

7. The method of claim 1, further comprising enabling beam refinement or multi-beam reception based on one or more Channel State Information (CSI)—Reference Signal (RS) reports.

8. The method of claim 1, wherein a synchronization signal/physical broadcast channel block (SSB), a common control resource set (CORESET), and a channel state information—reference signal/tracking reference signal (CSI-RS/TRS) have a matching sub-carrier spacing (SCS).

9. The method of claim 1, wherein a non-zero-power channel state information—reference signal/tracking reference signal (CSI-RS/TRS) is transmitted with a paging channel in a paging monitoring occasion and the CSI-RS/TRS is quasi co-located (QCLed) with a synchronization signal/physical broadcast channel block (SSB) and a Division Multiplexing Reference Signal (DM-RS) port of the PDCCH and the plurality of scheduled PDSCH.

10. The method of claim 1, further comprising:
monitoring, by the UE, a group common Physical Downlink Control Channel (PDCCH) before receiving a paging Physical Downlink Control Channel (PDCCH); and
determining, by the UE, a listen before talk failure if the group common PDCCH is not received for a plurality of channel state information—reference signal/tracking reference signal (CSI-RS/TRS) identifiers.

11. The method of claim 1, further comprising determining a beam failure detection based on an aperiodic channel state information - reference signal (CSI-RS).

12. An apparatus, the apparatus being a User Equipment (UE) comprising a processor, communications circuitry, and a memory comprising instructions which, when executed by the processor cause the apparatus to:
receive a plurality of Transmission Configuration Indication (TCI) states, wherein each of the TCI states corresponds to a Physical Downlink Control Channel (PDCCH) or a plurality of scheduled Physical Downlink Shared Data Channel (PDSCH); and
determine a channel estimator for channel estimation by combining each of the TCI states.

13. The apparatus of claim 10, wherein the plurality of TCI states are received for a multi-Transmission and Reception Point (TRP) environment.

14. The apparatus of claim 10, wherein both the PDCCH and the plurality of scheduled PDSCH are indicated using the same Quasi-CoLocation (QCL) information.

15. The apparatus of claim 10, wherein the TCI states are indicated in a Downlink Control Information (DCI) format.

16. The apparatus of claim 10, wherein the instructions further cause the apparatus to:
determine, based on a time offset between a reception of a downlink (DL) Downlink Control Information (DCI) and a corresponding PDSCH being equal to or greater than a threshold, a first Division Multiplexing Reference Signal (DM-RS) port of the PDSCH and a second Division Multiplexing Reference Signal (DM-RS) port of the PDCCH of a serving cell are Quasi-CoLocationed with one or more reference signals (RSs) in the plurality of TCI states.

17. The apparatus of claim 10, wherein the instructions further cause the apparatus to:
determine, based on a time offset between a reception of a downlink (DL) Downlink Control Information (DCI) and a corresponding PDSCH being less than a threshold, DM-RS ports of PDSCH are quasi co-located (QCLed) with the DM-RS of the current received DCI or a current Transmission Configuration Indication (TCI) state.

18. The apparatus of claim 10, wherein the instructions further cause the apparatus to:
enable beam refinement or multi-beam reception based on one or more Channel State Information (CSI)—Reference Signal (RS) reports.

19. The apparatus of claim 10, wherein a synchronization signal/physical broadcast channel block (SSB), a common control resource set (CORESET), and a channel state information—reference signal/tracking reference signal (CSI-RS/TRS) have a matching sub-carrier spacing (SCS).

20. The apparatus of claim 10, wherein a non-zero-power channel state information—reference signal/tracking reference signal (CSI-RS/TRS) is transmitted with a paging channel in a paging monitoring occasion and the CSI-RS/TRS is quasi co-located (QCLed) with a synchronization signal/physical broadcast channel block (SSB) and a Division Multiplexing Reference Signal (DM-RS) port of the PDCCH and the plurality of scheduled PDSCH.

21. The apparatus of claim 10, wherein the instructions further cause the apparatus to:
monitor a group common Physical Downlink Control Channel (PDCCH) before receiving a paging Physical Downlink Control Channel (PDCCH); and
determine a listen before talk failure if the group common PDCCH is not received for a plurality of channel state information—reference signal/tracking reference signal (CSI-RS/TRS) identifiers.

22. The apparatus of claim 10, wherein the instructions further cause the apparatus to determine a beam failure detection based on an aperiodic channel state information—reference signal (CSI-RS).

23. An apparatus, the apparatus being a next generation Node B (gNB) comprising a processor, communications circuitry, and a memory comprising instructions which, when executed by the processor cause the apparatus to:
transmit a paging message, wherein a scheduling request (SR) procedure is initiated based on the paging message; and
transmit a plurality of Transmission Configuration Indication (TCI) states, wherein each of the TCI states corresponds to a Physical Downlink Control Channel (PDCCH) or a plurality of scheduled Physical Downlink Shared Data Channel (PDSCH).
